(19) United States
(12) Patent Application Publication
(10) Pub. No.: US 2007/0253310 A1
(43) Pub. Date: Nov. 1, 2007

(54) Coupling Lens and Optical Pickup Apparatus

(76) Inventor: Kiyono Ikenaka, Tokyo (JP)

Correspondence Address: COHEN, PONTANI, LIEBERMAN & PAVANE, 551 FIFTH AVENUE, SUITE 1210, NEW YORK, NY, 10176, US

(21) Appl. No.: 11/661,511

(22) PCT Filed: Aug. 26, 2005
(86) PCT No.: PCT/JP05/15511

§ 371 Date: Feb. 26, 2007

(30) Foreign Application Priority Data
Sep. 30, 2004 (JP) 2004-257327

(51) Int. Cl. G11B 7/00

(52) U.S. Cl. 369/112.08; 369/112.07

(57) ABSTRACT

The present invention provides a coupling lens provided for achieving compatibility between a high-density optical disc and a CD which are in the relationship that the wavelength ratio between the working light fluxes substantially 1:2, and provide for emitting the two light fluxes with different angles by using a phase structure. The present invention further provides an optical pickup apparatus including the coupling lens. The coupling lens according to the present invention is provided with a first lens portion including a material whose Abbe number νd1 for d line satisfies 0<νd1≦40; and a first phase structure arranged in the first lens portion.

### TECHNICAL FIELD

The present invention relates to a coupling lens and an optical pickup apparatus.

### BACKGROUND ART

Up to this time, there has been advanced the development for optical information recording and reproducing apparatus having compatibility between optical discs of at least two types among a high density optical disc whose recording density has been enhanced by using a violet laser light source, DVD (digital versatile disc, which uses a red laser light source), CD (compact disc, which uses an infrared laser light source).

Incidentally, in the present specification, optical discs employing a violet laser light source such as Blu-ray disc (hereafter abbreviated as “BD”) using an objective lens with NA of 0.85 and having a 0.0875 mm-thick protective layer and HD DVD (hereafter abbreviated as “HD”) using an objective lens with NA of 0.65-0.67 and having a 0.6 mm-thick protective layer are generically called “high density optical disc”. In addition to the aforesaid Blu-ray disc and HD DVD, a magneto-optical disc, an optical disc having a protective film with a thickness of about several-several tens nm on an information recording surface and an optical disc having a protective layer or a protective film whose thickness is zero are also included in the high density optical disc.

From the viewpoint of downsizing and weight reduction of the apparatus, it is preferable that one optical device can record and reproduce information for plural types of optical discs, and it is further preferable that compatible components such as a light source and a sensor are shared by various light fluxes, by making an optical path from the light source to the sensor to be the same for various light fluxes.

Patent Document 1 discloses a technology in which there is provided a diffractive structure on a collimator lens, a laser beam with a short wavelength is emitted for DVD as collimated light, and a laser beam with a long wavelength is emitted for CD as divergent light, to correct spherical aberration caused by a difference of a protective substrate thickness between DVD and CD and by a wavelength difference between the light fluxes.

Patent Document 1: TOKUKAI No. 2002-245654

In the technology disclosed by the aforesaid Patent Document 1, however, it is difficult to attain compatibility for three types of optical discs including high density optical disc, DVD and CD.

The reason for the foregoing is that a wavelength of the infrared laser light source used for CD is about twice a wavelength of the violet laser light source used for the high density optical disc, and that it brings about a trade-off relationship between the effect of spherical-aberration correction for compatibility of diffracted light fluxes generated by the diffractive structure for the violet laser light flux and the infrared laser light flux; and the diffraction efficiency of the diffracted light.

Namely, if the technology in Patent Document 1 is applied for compatibility for the aforesaid three types of optical discs, a diffraction angle of the diffracted light of the violet laser light flux substantially agrees with a diffraction angle of the diffracted light of the infrared laser light flux, which causes a problem that spherical aberration caused by a protective layer thickness difference between the high density optical disc and CD cannot be corrected.

### DISCLOSURE OF THE INVENTION

In view of the aforesaid problems, an object of the invention is to provide a coupling lens for an optical pickup apparatus that can emit two light fluxes respectively at different angles by using a phase structure to attain compatibility between a high density optical disc and CD which have the relationship that the wavelength ratio between working light fluxes is substantially 1:2, and to provide an optical pickup apparatus in which the coupling lens is mounted.

To attain the aforesaid subject, the structure described in Item 1, is provided with a first lens portion that is made of a material whose Abbe number νd1 for d line satisfies 0<νd1≦40; and a phase structure arranged in the first lens portion.

It attains compatibility between a high density optical disc and CD which have the relationship that the wavelength ratio between working light fluxes is substantially 1:2, by providing a structure which includes a coupling lens formed of a high dispersion material and includes the phase structure.

In the present invention, the high dispersion material is a material whose Abbe number νd satisfies 40≦νd≦70. Further, a low dispersion material is a material whose Abbe number νd has smaller value than that of Abbe number of the high dispersion material.

### BRIEF DESCRIPTION OF DRAWINGS

FIG. 1 is a top view of primary portions showing the structure of an optical pickup apparatus.

FIG. 2 is a top view of primary portions showing the structure of a coupling lens.

FIG. 3 is a top view of primary portions showing the structure of a coupling lens.

Each of FIGS. 4(a) and 4(b) is a top view of primary portions showing a phase structure.

Each of FIGS. 5(a) and 5(b) is a top view of primary portions showing a phase structure.

Each of FIGS. 6(a) and 6(b) is a top view of primary portions showing a phase structure.

Each of FIGS. 7(a) and 7(b) is a top view of primary portions showing a phase structure.

FIG. 8 is a top view of primary portions illustrating a lens portion.

FIG. 9 is a top view of primary portions showing the structure of an objective optical element in Example.

FIG. 10 is a top view of primary portions showing the structure of an objective optical element in Example.

FIG. 11 is a top view of primary portions showing the structure of an objective optical element in Example.

FIG. 12 is a top view of primary portions showing the structure of an objective optical element in Example.

FIG. 13 is a top view of primary portions showing the structure of an objective optical element in Example.

FIG. 14 is a top view of primary portions showing the structure of an objective optical element in Example.

FIG. 15 is a top view of primary portions showing the structure of an objective optical element in Example.

### BEST MODE FOR CARRYING OUT THE INVENTION

Preferred embodiments of the invention will be explained as follows.

Item 2 provides the structure according to the coupling lens described in Item 1, in which the coupling lens is used for an optical pickup apparatus at least reproducing and/or recording information for a first optical information recording medium having a protective substrate with a thickness t1 by using a light flux with a wavelength λ1 emitted from a first light source, and reproducing and/or recording information for a third optical information recording medium having a protective substrate with a thickness t3 (1.44×t1≦t3) by using a light flux with a wavelength λ3 (1.9×λ1≦λ3≦2.2×λ1) emitted from a third light source. In the structure, the coupling lens transmits the light fluxes with the wavelengths λ1 and λ3.

Item 3 provides the structure according to the coupling lens described in Item 2, in which the coupling lens is used for an optical pickup apparatus at least reproducing and/or recording information for a first optical information recording medium having a protective substrate with a thickness t1 by using a light flux with a wavelength λ1 emitted from a first light source, reproducing and/or recording information for a second optical information recording medium having a protective substrate with a thickness t2 (0.9×t1≦t2) by using a light flux with a wavelength λ2 (1.5×λ1≦λ2≦1.8×λ1) emitted from a second light source, and reproducing and/or recording information for a third optical information recording medium having a protective substrate with a thickness t3 (1.6×t2≦t3≦2.4×t2) by using a light flux with a wavelength λ3 (1.9×λ1≦λ3≦2.2×λ1) emitted from a third light source. In the structure, the coupling lens transmits the light fluxes with the wavelengths λ1, λ2 and λ3.

Item 4 provides the structure according to the coupling lens described in any one of Items 1 to 3 further including: a second lens portion whose Abbe number νd2 for d line satisfies νd1<νd2.

Item 5 provides the structure according to the coupling lens described in Item 4, in which the first lens portion and the second lens portion are layered along an optical axis and the first phase structure is arranged at a boundary surface between the first lens portion and the second lens portion.

Item 6 provides the structure according to the coupling lens described in Item 4, in which the first lens portion and the second lens portion are layered along an optical axis and the first phase structure is arranged at a boundary surface between the first lens portion and an air.

By making the objective optical element to be of the structure of Item 2, it is possible to emit a light flux with wavelength λ1 (for example, violet laser light flux with about wavelength λ1=407 nm) and a light flux with wavelength λ3 (for example, infrared laser light flux with about wavelength λ3=785 nm) which are in the relationship that a wavelength ratio is substantially 1:2, at different angles by using a phase structure. Therefore, it enables to, for example, correct spherical aberration and maintain transitivity.

Further, though a coupling lens may be made of high dispersion material alone as described in Item 1, it is preferable to combine low dispersion material and high dispersion material and to form a phase structure on the high dispersion material to reduce spherical aberration caused by changes in oscillation wavelength resulted from individual differences.

Therefore, each of the structures of Items 4 to 6 is provided with a coupling lens which includes: at least a first lens portion comprising material A whose Abbe number νd1 for d line satisfies 0<νd1≦40; and a second lens portion comprising material B whose Abbe number νd2 for d line satisfies νd1<νd2, which are layered along the optical axis. The coupling lens further includes the phase structure arranged at a boundary surface between the both lens portions or a boundary surface between the first lens portion and the air space.

Owing to this, the structure can be used as a coupling lens in which an amount of generation of spherical aberration is controlled, even when an oscillation wavelength is changed by individual differences in lasers, and can be used as a coupling lens for providing compatibility for the first to third optical information recording media.

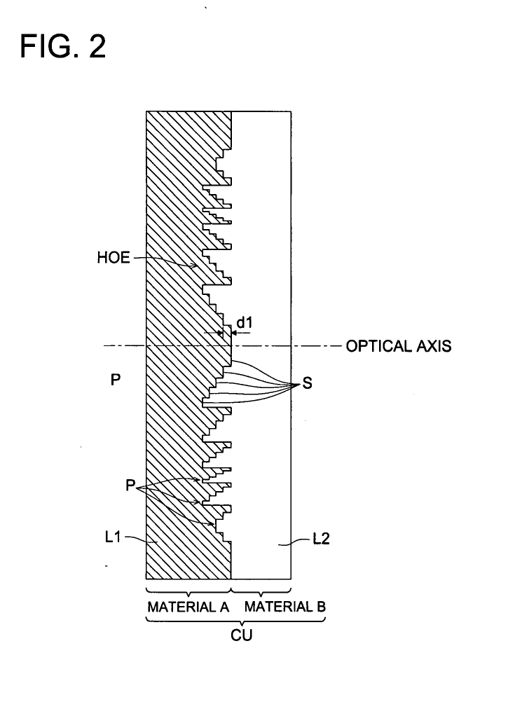

There is provided diffractive structure HOE (see FIG. 2), representing an example of the phase structure, which is arranged at a boundary surface between: the first lens portion formed of a material (material A, high dispersion material) whose Abbe number νd1 for d line satisfies 0<νd1≦40; and the second lens portion formed of a material (material B, low dispersion material) whose Abbe number νd2 for d line satisfies νd1<νd2. Diffractive structure HOE includes patterns concentrically arranged around the optical axis and each of the patterns has a cross section including the optical axis in a stepped shape. Each of the patterns is formed of a plurality of steps (five steps in FIG. 2).

In an embodiment in which diffractive structure HOE is formed on the surface of a coupling lens, for example, when the diffractive structure is designed to transmit a light flux with wavelength λ1, namely, not to substantially provide a phase difference to the transmitted light flux with wavelength λ1, following expression (1) holds, where d1 represents a depth in the optical axis direction of each of plural steps constituting the pattern, n_{C407} represents a refractive index for wavelength λ1 (=407 nm) of material C constituting the coupling lens, n_{C785} represents a refractive index for wavelength λ2 (=785 nm) of material C and a refractive index of the air is 1.
d1(n_{C407}−1)≈407×N1 (N1 is a natural number)

When a light flux with wavelength λ2 enters the diffractive structure designed in the aforesaid way, following expression (2) holds.
d1(n_{C785}−1)≈785×N1/2

According to these expressions, a ratio of refractive index differences between material C and an air space, represented by (n_{C407}−1)/(n_{C785}−1), is sufficiently close to 1, compared with a wavelength ratio of incident light fluxes (407:785≈1:2). Thereby, a left-hand side of expression (1) and a left-hand side of expression (2) are substantially the same each other in terms of a value, and a value by which 785 on the right-hand side of expression (2) is multiplied becomes a half of natural number N1. Then, it results in that a phase difference given by each ring-shaped zone of the diffractive structure to entering light fluxes becomes the same for a light flux of wavelength λ1 and for a light flux of wavelength λ3, and the light fluxes are diffracted or passes through in the same direction, when N1 is an even number.

In an embodiment in which a diffractive structure is formed on a surface of a material with ordinary dispersion (Abbe number νd, 40≦νd≦70), for example, when this diffractive structure is designed to transmit a light flux with wavelength λ1, namely, not to substantially provide a phase difference to the transmitted light flux with wavelength λ1, the following expression (3) holds, where d1 represents a depth in the optical axis direction of each of plural steps constituting each pattern of the diffractive structure representing a phase structure, n_{A407} represents a refractive index of material A for wavelength λ1 (=407 nm), n_{B407} represents a refractive index of material B for wavelength λ1 (=407 nm), n_{A785} represents a refractive index of material A for wavelength λ3 (=785 nm) and n_{B785} represents a refractive index of material B for wavelength λ3 (=785 nm).
d1(n_{A407}−n_{B407})=d1(1−n_{B407})≈407×N2 (N2 is a natural number)

When a light flux with wavelength λ3 enters the diffractive structure designed as stated above, the following expression (4) holds.
d1(n_{A785}−n_{B785})=d1(1−n_{B785})≠785×N3 (N3 is a natural number)

When a coupling lens is constituted as stated above, a ratio of refractive index differences between material A and material B, represented by (n_{A407}−n_{B407})/(n_{A785}−n_{B785}), is sufficiently away from 1 because of different dispersion, compared with a ratio of wavelength of an incident light flux (407:785≈1:2). Whereby, the left-hand side of expression (3) is different from the left-hand side of expression (4) in terms of a value. Therefore, value N3 by which 785 on the right-hand side of expression (4) is multiplied does not become a half of natural number N2. Then, it results in that it is possible to give a desired difference of diffraction angle for a light flux with wavelength λ1 and a light flux with wavelength λ3, by selecting a combination of dispersion freely.

Incidentally, the same effect can be obtained, even when a material having abnormal dispersibility is used in place of a high dispersion material.

Though many of the high dispersion materials have birefringence, it is possible to reduce an influence of the birefringence by making a volume ratio of the high dispersion material to be minimum, even when such material is selected.

Even when a resin, to say nothing of a glass, is selected as a low dispersion material, the aforesaid coupling lens includes at least two layers each having a different Abbe number which are layered. Therefore, it has the larger number of boundary surfaces (refracting interfaces) compared with a single lens composed of only one type of optical material. Therefore, it allows, for example, to correct spherical aberration when temperature changes by providing a second phase structure on these boundary surfaces as described in Item 13.

Further, when considering a method of manufacturing the layered type lens of this kind, the lens can be manufactured easily, for the high dispersion material which is UV curing resin, by projecting light to materials under the condition that the resin is directly poured on the low dispersion material or that a formed lens made of a low dispersion material is held down on the fluid resin. Alternatively, when the low dispersion material is resin, it enables to provide a diffractive structure on the boundary surface between the low dispersion material and the high dispersion material.

When moldability of the high dispersion material is inferior in these cases, it is better to form a phase structure on the boundary surface between the first lens portion and the second lens portion as described in Item 5 rather than on the surface of the first lens portion. The reason for the foregoing is that it allows the manufacturing method in which the second lens portion having a phase structure on its surface is prepared, and then, resin is poured on a surface of the phase surface.

When the high dispersion material has the same moldability as that of an ordinary dispersion material, a first lens portion can be made through a conventional manufacturing method by employing the structure described in Item 6.

Further, when the structure of the invention is applied on an objective lens, namely, when the objective lens is provided with a high dispersion material and a low dispersion material which are layered in the optical axis direction, the objective lens becomes large in its optical axis direction. Thereby, a distance from a rising mirror used generally as a constitution of an optical pickup apparatus to an optical information recording medium becomes longer, which is not suitable for an optical pickup apparatus of a slim type (or a type of smaller than that) used for a personal computer. However, the present invention provides a coupling lens that is often arranged between a light source and a rising mirror, and that includes a high dispersion material and a low dispersion material which are layered in the optical axis direction. Therefore, the coupling lens is suitable even for an optical pickup apparatus of a slim type (or a type of smaller than that) for use in a personal computer.

Meanwhile, DVD in the present specification represents a generic name of optical discs in DVD group such as DVD-ROM, DVD-Video, DVD-Audio, DVD-RAM, DVD-R, DVD-RW, DVD+R and DVD+RW, while, CD represents a generic name of optical discs in CD group such as CD-ROM, CD-Audio, CD-Video, CD-R and CD-RW.

In the present specification, a coupling lens means an optical element having a function to emit a light flux with changing its angle from the incident angle, and it includes an optical element having a so-called collimating function to emit an emitting light flux as a collimated light flux.

A collimated light flux in the present specification means the state where the optical system magnification of the coupling lens for the passing light flux is 0 when it is defined strictly, but the collimated light may also include the state where the optical system magnification is within a range of ± 1/100.

The phase structure stated above may be either a diffractive structure or an optical path difference providing structure. Examples of the diffractive structure are: a structure including a plurality of ring-shaped zones 100 and having a cross-sectional form including an optical axis in a serrated shape as schematically shown in FIGS. 4(a) and 4(b) (diffractive structure DOE); a structure including a plurality of ring-shaped zones 102 whose step differences 101 extend in the same direction within an effective diameter, having a cross-sectional form including an optical axis in stepwise as shown schematically in FIGS. 5(a) and 5(b) (diffractive structure DOE); a structure including a plurality of ring-shaped zones 105 whose step differences 104 extend in a direction switched on the half way in an effective diameter, and having cross-sectional form including an optical axis in stepwise as is shown schematically in FIGS. 6(a) and 6(b) (diffractive structure DOE); and a structure including a plurality of ring-shaped zones 103 each having a stepwise structure as shown schematically in FIGS. 7(a) and 7(b) (diffractive structure HOE). Further, examples of the optical path difference providing structure are: a structure including a plurality of ring-shaped zones 105 whose step differences 104 extending in a direction switched on the half way in an effective diameter, and having a cross-sectional form including an optical axis in stepwise as is shown schematically in FIGS. 6(a) and 6(b) (NPS). In the meanwhile, each of FIGS. 5(a) to 7(b) schematically shows an example in which the phase structure is formed on a flat surface. However, each phase structure may also be formed on a spherical surface or an aspheric surface. Further, any of the diffractive structure or the optical path difference providing structure sometimes has a structure schematically shown in FIGS. 6(a) and 6(b).

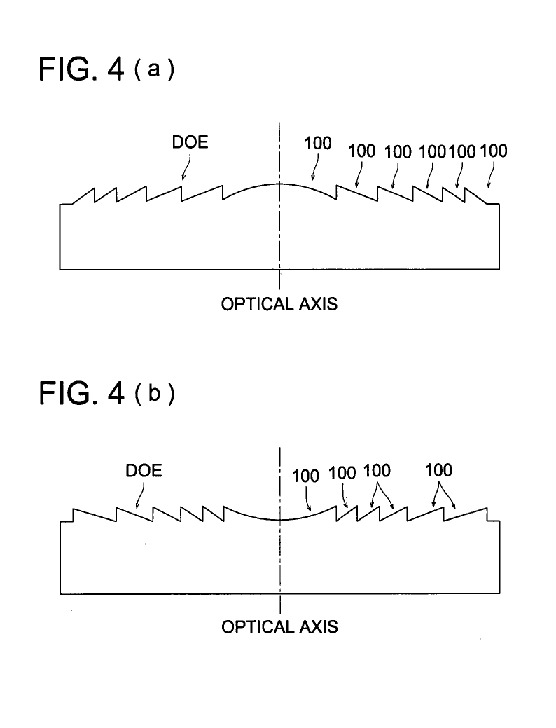

Further, FIG. 8 shows coupling lens CU including a plurality of materials whose Abbe number νd1 for d line satisfies 0<νd1≦40 (for example, two types of materials including material α1 whose Abbe number νd is 20 and material α2 whose Abbe number νd is 30) and a material whose Abbe number νd2 for d line satisfies νd1<νd2 (for example, material β whose Abbe's number νd is 50), which are layered in the order of α1, β, and α2 from the light source side in the optical axis direction. When the coupling lens is provided, a part in which a portion formed of the material α1 and a portion formed of the material α2 are combined corresponds to “a first lens portion including a material whose Abbe number νd1 for d line satisfies 0<νd1≦40”, and a portion formed of material β corresponds to “a second lens including a material whose Abbe number νd2 satisfies νd1<νd2”.

Item 7 provides the structure according to the coupling lens described in any one of Items 1 to 5, in which the first phase structure includes patterns concentrically arranged therein. Each of the patterns has a cross section including an optical axis in a stepped shape.

The structure described in Item 7 allows to emit light fluxes with high diffraction efficiency for light fluxes with three wavelengths and allows to provide a diffractive function to the light flux with the wavelength λ3, which is different from that to the light flux with the wavelength λ1. Further, the phase structure is formed on a boundary surface between the first lens portion and the second lens portion which has high degree of flatness. Therefore, it enhances moldability of the phase structure and reduces an effect of a shadow of the phase structure.

Item 8 provides the structure according to the coupling lens described in any one of Items 1 to 4, and 6, in which the first phase structure includes a plurality of ring-shaped zones concentrically arranged around an optical axis, and has a cross section including the optical axis in a serrated shape.

In the structure described in Item 8, each of the light fluxes with the wavelengths λ1, λ2, and λ3 is diffracted. Therefore it allows to provide a diffractive effect to the every light fluxes with the wavelengths λ1, λ2, and λ3. For example, the structure corrects a spherical aberration of the light flux with the wavelength λ2 for providing compatibility, with providing a chromatic-aberration correcting function with the light flux with the wavelength λ1, which was impossible in a shape, for example, including patterns concentrically arranged therein and each having a stepped cross section. Further, the structure is designed so that the steps of the phase structure always extend in the same direction of the optical axis. Therefore, it enhances processability of the phase structure.

Item 9 provides the structure according to the coupling lens described in Item 2, which satisfies m_{CU1}≠m_{CU3}, where m_{CU1} is an optical system magnification of the coupling lens for the light flux with the wavelength λ1, and M_{CU3} is an optical system magnification of the coupling lens for the light flux with the wavelength λ3.

Item 10 provides the structure according to the coupling lens described in Item 3, which satisfies m_{CU1}≠m_{CU2}, where m_{CU2} is an optical system magnification of the coupling lens for the light flux with the wavelength λ2.

By satisfying the condition of m_{CU1}≠m_{CU3} as the structure described in Item 9, it is possible to make a light flux with wavelength λ1 and a light flux with wavelength λ3 to be different in terms of an incident angle when the light fluxes enter into an objective lens of an optical pickup apparatus. Thereby, it corrects aberrations caused by differences of a protective substrate thickness and a wavelength between the first optical information recording medium and the third optical information recording medium. Owing to this, there is no need to provide a phase structure for correcting the aberrations on the objective lens, and an optical surface of the objective lens can be constituted of a refracting interface, which makes it possible to enhance productivity of objective lenses.

Further, since an optical path length from the coupling lens to the light source can be determined independently for light with wavelength λ1 and light with wavelength λ3, it is possible to establish the optical path length so that it may fit to a size and a form of the optical pickup apparatus.

By satisfying the condition of m_{CU1}≠m_{CU2} as the structure described in Item 10, it is possible to make a light flux with wavelength λ1 and a light flux with wavelength λ2 to be different in terms of an angle of incidence when the light fluxes enter into an objective lens of an optical pickup apparatus. Thereby, it corrects aberrations caused by differences of a protective substrate thickness and a wavelength between the first optical information recording medium and the second optical information recording medium.

On the other hand, the structure can correct also spherical aberration caused by temperature change, because a magnification can be changed in accordance with a wavelength.

Item 11 provides the structure according to the coupling lens described in any one of Items 1 to 10, in which the first phase structure is a diffractive structure.

The structure described in Item 11 allows to change the emitting direction of a light flux by providing a diffractive function with a passing light flux using the diffractive structure.

Item 12 provides the structure according to the coupling lens described in any one of Items 4 to 11, which satisfies 40<νd2≦70.

Item 13 provides the structure according to the coupling lens described in any one of Items 4 to 12, further including: a second phase structure arranged at a boundary between the second lens portion and an air space.

Even when a resin, to say nothing of a glass, is selected as a low dispersion material, the aforesaid coupling lens includes at least two layers each having a different Abbe number which are layered. Therefore, it has the number of boundary surfaces (refracting interfaces) compared with a single lens composed of only one type of optical material. Therefore, it allows, for example, to correct spherical aberration when temperature changes by providing a second phase structure on these boundary surfaces as described in Item 11.

Item 14 provides the structure according to the coupling lens described in Item 13, in which the second phase structure includes a plurality of ring-shaped zones concentrically arranged around an optical axis, and has a cross section including the optical axis in a serrated shape.

The structure described in Item 13 allows to provide a diffractive function with the light flux with the wavelength λ1 having been passed through the phase structure by the phase structure.

Further, light fluxes respectively with three wavelengths of λ1, λ2 and λ3 enter the phase structure. When the structure provides the high diffraction efficiency for each of the light fluxes with λ1 and λ3, the structure provides high diffraction efficiency also for the light flux with λ2. Therefore, it is enough to consider the diffraction efficiency for the light fluxes with λ1 and λ3 alone, for designing lenses.

Further, when the first optical information recording medium is HD DVD, there is sometimes an occasion where the aforesaid diffractive structure for compatibility for HD DVD and CD attains compatibility for DVD serving as the second optical information recording medium, depending on specifications such as a focal length and a thickness of an objective lens on the axis. However, when it is impossible to attain compatibility, a structure can attain compatibility also for DVD by providing the second phase structure formed on the second lens portion made of a material having small dispersion, as described in Items 13 or 14.

For example, when the structure is provided with an objective lens made of resin, in addition to attaining compatibility by a coupling lens for HD DVD and DVD, it is possible to control coma in the case of shifting an objective lens, while attaining compatibility.

Item 15 provides the structure according to the coupling lens described in any one of Items 1 to 14, in which the coupling lens is used for the optical pickup apparatus at least reproducing and/or recording information for a first optical information recording medium having a protective substrate with a thickness t1 by using a light flux with a wavelength λ1 emitted from a first light source, and reproducing and/or recording information for a third optical information recording medium having a protective substrate with a thickness t3 (1.44×t1≦t3) by using a light flux with a wavelength λ3 (1.9×λ1≦λ3≦2.2×λ1) emitted from a third light source. In the structure, the coupling lens transmits the light fluxes with the wavelengths λ1 and λ3, and the coupling lens emits a light flux with the wavelength λ1 as a convergent light flux, and emits a light flux with the wavelength λ3 as a divergent light flux, for recording and/or reproducing information using the optical pickup apparatus.

Item 16 provides the structure according to the coupling lens described in Item 15, in which the coupling lens is used for the optical pickup apparatus at least reproducing and/or recording information for a first optical information recording medium having a protective substrate with a thickness t1 by using a light flux with a wavelength λ1 emitted from a first light source, reproducing and/or recording information for a second optical information recording medium having a protective substrate with a thickness t2 (0.9×t1≦t2) by using a light flux with a wavelength λ2 (1.5×λ1≦λ2≦1.8×λ1) emitted from a second light source, and reproducing and/or recording information for a third optical information recording medium having a protective substrate with a thickness t3 (1.6×t2≦t3≦2.4×t2) by using a light flux with a wavelength λ3 (1.9×λ1≦λ3≦2.2×λ1) emitted from a third light source. In the structure, the coupling lens transmits the light fluxes with the wavelengths λ1, λ2 and λ3, and the coupling lens emits a light flux with the wavelength λ1 as a convergent light flux, and emits a light flux with the wavelength λ3 as a divergent light flux, for recording and/or reproducing information using the optical pickup apparatus.

When compatibility between the first optical information recording medium and the third optical information recording medium is not attained by the objective lens, or when the compatibility is attained partially, either one of light fluxes enters the objective lens as finite light. When one of the light fluxes is a collimated light, a finite magnification for the other light flux is large, resulting in a problem of an amount of generation of coma in the case of tracking. Therefore, the structure is designed to emit a light flux with wavelength λ1 from the coupling lens as a convergent light flux, and to emit the light with wavelength λ3 from the coupling lens, for example, as a divergent light flux, as shown in Item 16, which results in distributing for two wavelengths. It provides tracking characteristics which are free from problems for both light fluxes.

Item 17 provides the structure according to the coupling lens described in Item 16, in which the coupling lens emits a light flux with the wavelength λ2 as a convergent light flux for recording and/or reproducing information using the optical pickup apparatus.

Item 18 provides the structure according to the coupling lens described in any one of Items 1 to 17, in which the coupling lens is used for the optical pickup apparatus at least reproducing and/or recording information for a first optical information recording medium having a protective substrate with a thickness t1 by using a light flux with a wavelength λ1 emitted from a first light source, and reproducing and/or recording information for a third optical information recording medium having a protective substrate with a thickness t3 (1.44×t1≦t3) by using a light flux with a wavelength λ3 (1.9×λ1≦λ3≦2.2×λ1) emitted from a third light source. In the structure, the coupling lens transmits the light fluxes with the wavelengths λ1 and λ3, and the coupling lens includes a collimating function for at least one light flux between the light fluxes with the wavelengths λ1 and λ2.

Item 19 provides the structure according to the coupling lens described in Item 18, in which the coupling lens is used for the optical pickup apparatus at least reproducing and/or recording information for a first optical information recording medium having a protective substrate with a thickness t1 by using a light flux with a wavelength λ1 emitted from a first light source, reproducing and/or recording information for a second optical information recording medium having a protective substrate with a thickness t2 (0.9×t1≦t2) by using a light flux with a wavelength λ2 (1.5×λ1≦λ2≦1.8×λ1) emitted from a second light source, and reproducing and/or recording information for a third optical information recording medium having a protective substrate with a thickness t3 (1.6×t2≦t3≦2.4×t2) by using a light flux with a wavelength λ3 (1.9×λ1≦λ3≦2.2×λ1) emitted from a third light source. In the structure, the coupling lens transmits the light fluxes with the wavelengths λ1, λ2 and λ3, and the coupling lens includes a collimating function for at least one light flux among the light fluxes with the wavelengths λ1, λ2 and λ3.

An amount of generation of coma in tracking operation can be controlled by providing a collimating function with the structure for at least one light flux among light fluxes with wavelengths λ1 to λ3, as described in Items 18 and 19. It is preferable, in particular, to provide the collimating function to the light with wavelength λ2. Owing to this, chromatic aberration on the objective lens caused by a wavelength difference between wavelengths λ1 and λ2 can be corrected by a coupling lens.

When, for attaining a part of compatibility between the first optical information recording medium and the third optical information recording medium is conducted by the objective lens, either one of the light fluxes with wavelength λ1 and wavelength λ3 is made to be a collimated light and the structure does not cause a trouble on the tracking characteristic for the other light flux, it is preferable to provide the structure in which a coupling lens has a collimating function for the light flux having a large numerical aperture and shorter wavelength λ1 among the aforesaid two light fluxes.

The structure described in Item 20 is an optical pickup apparatus which includes: a first light source emitting a light flux with a wavelength λ1 for reproducing and/or recording information for a first optical information recording medium having a protective substrate with a thickness t1; a third light source emitting a light flux with a wavelength λ3 (1.9×λ1≦λ3≦2.2×λ1) for reproducing and/or recording information for a third optical information recording medium having a protective substrate with a thickness t3 (1.44×t1≦t3); an objective optical element converging the light fluxes with the wavelengths λ1 and λ3 onto the first optical information recording medium and the third optical information recording medium, respectively; and the coupling lens of Item 1.

Item 21 provides the structure according to the optical pickup apparatus described in Item 20, which includes: a first light source emitting a light flux with a wavelength λ1 for reproducing and/or recording information for a first optical information recording medium having a protective substrate with a thickness t1; a second light source emitting a light flux with a wavelength λ2 (1.5×λ1≦λ2≦1.8×λ1) for reproducing and/or recording information for a second optical information recording medium having a protective substrate with a thickness t2 (0.9×t1≦t2); a third light source emitting a light flux with a wavelength λ3 (1.9×λ1≦λ3≦2.2×λ1) for reproducing and/or recording information for a third optical information recording medium having a protective substrate with a thickness t3 (1.6×t2≦t3≦2.4×t2); an objective optical element converging the light fluxes with the wavelengths λ1 and λ3 onto the first optical information recording medium and the third optical information recording medium, respectively; and the coupling lens of Item 20.

Item 22 provides the structure according to the optical pickup apparatus described in Item 20, in which the first light source and the third light source are integrally formed as one body.

Item 23 provides the structure according to the optical pickup apparatus described in Item 21, in which the second light source and the third light source are integrally formed as one body.

Item 24 provides the structure according to the optical pickup apparatus described in Item 21, in which the first light source, the second light source and the third light source are integrally formed as one body.

By unitizing the first light source and the third light source, or by unitizing the second light source and the third light source, or by unitizing all of the first to third light sources, as described in Items 22 to 24, the number of components of the optical pickup apparatus can be reduced.

### EXAMPLES

Preferred embodiments for practicing the invention will be explained in detail as follows, referring to the drawings.

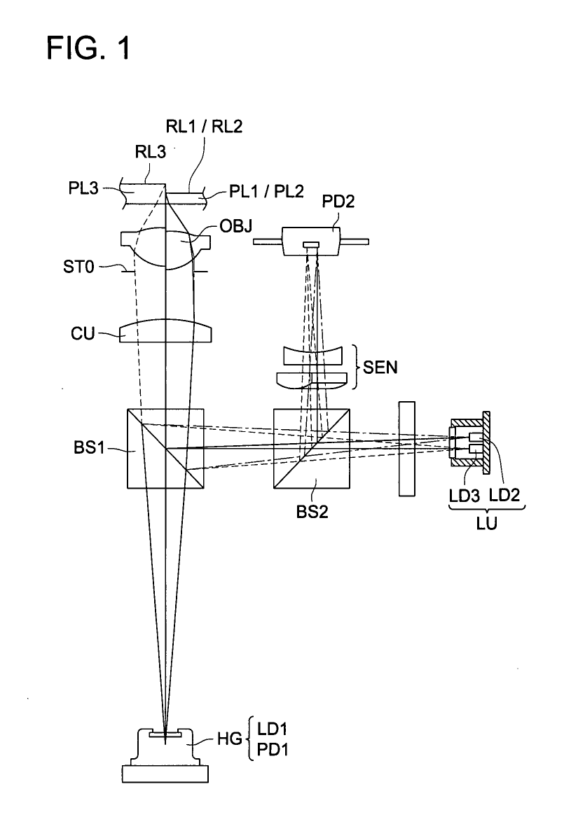

FIG. 1 is a diagram schematically showing the structure of optical pickup apparatus PU capable of conducting recording and reproducing of information properly for any of HD (a first optical information recording medium), DVD (a second optical information recording medium) and CD (a third optical information recording medium). In the optical specifications of HD, wavelength λ1 is 407 nm, thickness t1 is 0.6 mm for protective layer (protective substrate) PL1 and numerical aperture NA1 is 0.65. In the optical specifications of DVD, wavelength λ2 is 655 nm, thickness t3 is 0.6 mm for protective layer PL2 and numerical aperture NA2 is 0.65. In the optical specifications of CD, wavelength λ3 is 785 nm, thickness t3 is 1.2 mm for protective layer PL2 and numerical aperture NA3 is 0.51.

The present embodiment has the structure wherein the first light flux and the second light flux enter an objective optical element as a convergent light flux and the third light flux enters the objective optical element as a divergent light flux.

However, a combination of a wavelength, a thickness of a protective layer, a numerical aperture and an optical system magnification is not limited to the foregoing. Further, as the first optical information recording medium, it is also possible to use BD in which thickness t1 of protective layer PL1 is about 0.1 mm.

Optical pickup apparatus PU is composed of hologram laser HG in which violet semiconductor laser LD1 (first light source) that is ignited when conducting recording and reproducing of information for HD and emits laser light flux (first light flux) with wavelength 407 nm and photodetector PD1 for the first light flux are integrally formed as one body; light source unit LU in which red semiconductor laser LD2 (second light source) that is ignited when conducting recording and reproducing of information for DVD and emits laser light flux (second light flux) with wavelength 655 nm and infrared semiconductor laser LD3 (third light source) that is ignited when conducting recording and reproducing of information for CD and emits laser light flux (third light flux) with wavelength 785 nm are integrally formed as one body; optical detector PD2 that is common for the second and third light fluxes; coupling lens CU through which the first to third light fluxes pass; objective optical element OBJ on which both surfaces are aspheric surfaces and have a function to converge the first to third light fluxes on information recording surfaces RL1, RL2 and RL3; first beam splitter BS1; second beam splitter BS2; diaphragm STO; and sensor lens SEN.

In the optical pickup apparatus PU, when conducting recording and reproducing of information for high density optical information recording medium HD, violet semiconductor laser LD1 is ignited first as its beam path is drawn with solid lines in FIG. 1. A divergent light flux emitted from violet semiconductor laser LD1 passes through first beam splitter BS1 to arrive at coupling lens CU.

Then, the first light flux passing through coupling lens CU, is converted into a convergent light flux, and arrives at objective optical element OBJ to become a spot to be formed by objective optical element OBJ on information recording surface RL1 through the first protective layer PL1. The objective optical element OBJ is subjected to focusing and tracking conducted by biaxial actuator (not shown) arranged around itself.

A reflected light flux is modulated by information pits on information recording surface RL1, and passes again through objective optical element OBJ, coupling lens CU and first beam splitter BS1 to be converged on a light-receiving surface of photodetector PD1. Then, information recorded on HD can be read by using signals outputted from the photodetector PD1.

Further, when conducting recording and reproducing of information for DVD, red semiconductor laser LD2 is first ignited, as is shown by its beam path drawn with one-dot chain lines in FIG. 1. A divergent light flux emitted from the red semiconductor laser LD2 passes through the second beam splitter BS2 and is reflected by the first beam splitter BS1 to arrive at coupling lens CU.

Then, the second light flux passing through the coupling lens CU, is converted into a convergent light flux, and it arrives at objective optical element OBJ to become a spot that is formed by the objective optical element OBJ on information recording surface RL2 through the second protective layer PL2. The objective optical element OBJ is subjected to focusing and tracking which are conducted by a biaxial actuator arranged around the objective optical element OBJ.

The reflected light flux is modulated by information pits on information recording surface RL2 and passes again through objective optical element OBJ and coupling lens CU. The light flux is branched by the second beam splitter BS2 after being reflected by the first beam splitter BS1. Then, the light flux is given astigmatism in the course of passing sensor lens SEN, and is converged on a light-receiving surface of photodetector PD2. Then, information recorded on DVD can be read by using signals outputted from the photodetector PD2.

Further, when conducting recording and reproducing of information for CD, infrared semiconductor laser LD3 is first ignited, as is shown by its beam path drawn with dotted lines in FIG. 1. A divergent light flux emitted from the infrared semiconductor laser LD3 passes through the second beam splitter BS2 and is reflected by the first beam splitter BS1 to arrive at coupling lens CU.

Then, the third light flux passing through the coupling lens CU, is converted into a divergent light flux, and it arrives at objective optical element OBJ to become a spot that is formed by the objective optical element OBJ on information recording surface RL3 through the third protective layer PL3. The objective optical element OBJ is subjected to focusing and tracking which are conducted by a biaxial actuator arranged around the objective optical element OBJ.

The reflected light flux is modulated by information pits on information recording surface RL3 and passes again through objective optical element OBJ and coupling lens CU. The light flux is branched by the second beam splitter BS2 after being reflected by the first beam splitter BS1, then, is given astigmatism in the course of passing sensor lens SEN, and is converged on a light-receiving surface of photodetector PD2. Then, information recorded on CD can be read by using signals outputted from the photodetector PD2.

Next, the constitution of coupling lens CU will be explained.

As shown schematically in FIG. 2, the coupling lens CU includes first lens portion L1 made of a material whose Abbe's number νd1 for d line satisfies 0<νd1≦40 (material A) and second lens portion L2 made of a material whose Abbe's number νd2 for d line satisfies νd1<νd2 (material B), which are layered along the optical axis.

Polystyrene or polycarbonate, for example, can be given as a material of the first lens portion, and APEL (brand name) of Mitsui Chemicals, Inc., for example, can be given as a material of the second lens portion.

On the boundary surface between the first lens portion and the second lens portion, there is formed a first phase structure.

In the present embodiment, there is formed diffractive structure HOE, as the first phase structure, including patterns P which are arranged in a form of concentric circles and each of which has a sectional view including an optical axis in stepped shape.

In the diffractive structure HOE, depth d1 in the optical axis direction of step S formed in each pattern is established to satisfy 0.8×λ1×K2/(n_{A1}−nB1)≦d1≦1.2×λ1×K2/(nA1−nB1).

In the aforesaid expression, nA1 represents the refractive index of the aforesaid material A for the light flux with wavelength λ1, nB1 represents the refractive index of the aforesaid material B for the light flux with wavelength λ1 and K2 represents a natural number.

By establishing depth d1 in the optical axis direction in the aforesaid way, the light flux with wavelength λ1 passes through the diffractive structure HOE without being given a phase difference substantially. Further, the light flux with wavelength λ2 is given a phase difference in the diffractive structure HOE substantially, and is subjected to diffracting actions, because a ratio of refractive index differences between material A and material B grows greater sufficiently as stated above due to a difference of dispersion between the materials.

In this case, depth d1 between neighboring ring-shaped zones (steps) is established to be d=0.407×5/(1.6365−1.5598)=26.5 [μm] in this diffractive structure, under the condition that: nA1 is 1.6365, nB1 is 1.5598, refractive index nA2 of material A for wavelength λ2 is 1.5919, nA3 for wavelength λ3 is 1.5845, refractive index nB2 of material B for wavelength λ2 is 1.5407, nB3 for wavelength λ3 is 1.5372. Therefore, when a light flux with wavelength λ1 of 0.407 [μm] enters this diffractive structure, a phase difference of 2π×3 is generated between neighboring ring-shaped zones, and a substantial phase difference is not generated. In other words, the light flux passes there at high efficiency (100%).

When a light flux with wavelength λ3 of 0.785 [μm] enters the diffractive structure, a phase difference of d1×(1.5845−1.5372)/0.785=2π×1.60 is generated between neighboring ring-shaped zones. When the diffractive structure is formed to provide five steps per one cycle, the phase difference becomes 2π×1.60×3=2π×4.80, which is close to an integer value. Whereby, the light flux is diffracted at high diffraction efficiency (60%).

Further, when a light flux with wavelength λ2 of 0.655 [μm] enters the diffractive structure, a phase difference of 2π×d1×(1.5919−1.5407)/0.655=2π×2.07 is generated between neighboring ring-shaped zones, which does not cause the substantial phase difference. Therefore, the light flux passes there at high diffraction efficiency (86%).

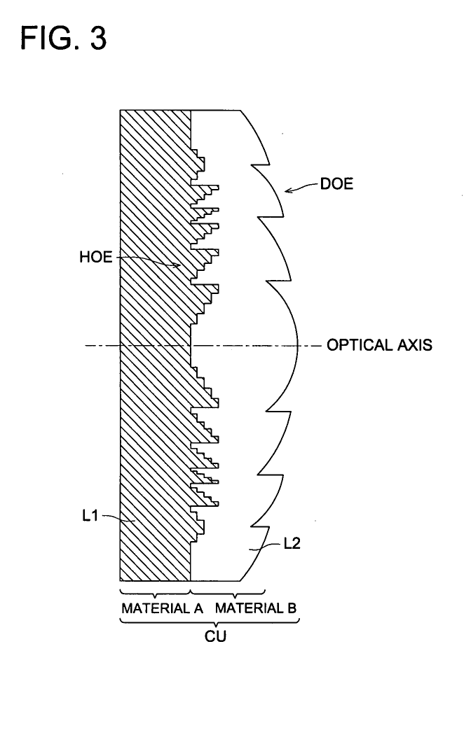

Incidentally, the constitution in FIG. 2 may further include the first phase structure which is formed on an incident surface (optical surface on the light source side) of the first lens portion. Alternatively, the constitution in FIG. 2 may include the diffractive structure DOE as the second phase structure arranged on a boundary surface between the second lens portion and an air space, as shown in FIG. 3, which includes plural ring-shaped zones concentrically arranged around the optical axis, and which has the sectional view including the optical axis in a serrated shape.

For example, when the first optical information recording medium and the second optical information recording medium are the same in terms of a protective substrate thickness (t1=t2) as in the present embodiment, chromatic spherical aberration caused by a difference between wavelength λ1 and wavelength λ2 can be corrected by making at least one optical surface of objective optical element OBJ to be a refractive surface. When correcting it with a refractive surface, at least three aspheric surfaces of objective optical element OBJ are needed. When correcting the chromatic spherical aberration with a diffractive surface on which the diffractive structure DOE is formed, it is possible to make the diffractive surface to have a chromatic aberration correcting function to cope with mode-hop of the first optical information recording medium.

As stated above, the optical pickup apparatus PU shown in the present embodiment allows to emit, at different angles, both of a light flux with wavelength λ1 (violet laser light flux with wavelength λ1 of about 407 nm, for example) and a light flux with wavelength λ3 (infrared laser light flux with wavelength λ3 of about 785 nm, for example), which have a relationship that a wavelength ratio is substantially a ratio of integers, by utilizing the diffractive structure HOE. Therefore, it secures, for example, correction of spherical aberration and transmittance.

The present embodiment provides light source unit LU in which red semiconductor laser LD2 and infrared semiconductor laser LD3 are integrally formed as one body. However, there may be provided a light source unit such as a light source unit wherein violet semiconductor laser LD1 and infrared semiconductor laser LD3 are integrally formed as one body; and a laser light source unit for HD/DVD/CD in which the violet semiconductor laser LD1 (first light source) is additionally housed in one casing, without being limited to the foregoing. Alternatively, these three light sources may be provided as separate bodies.

As a method for layering optical resins on optical glass, there is a method (so-called insert molding) in which a diffractive structure is formed on a surface of an optical glass, which is used as a die, and an optical resin is molded on the optical glass. In addition to the foregoing, there is a method in which a phase structure is formed on one surface of an optical glass and UV curing resin is layered on the optical glass, and then the UV curing resin is hardened by applying ultraviolet radiation, which is suitable for manufacturing. It is preferable that a surface on the other side of UV curing resin is a flat surface for this method.

Further, the followings are fitted to mass production as a method of manufacturing optical glass on which a phase structure is formed: a method in which a phase structure is directly formed on an optical glass substrate by repeating processes of photo-lithography and etching; and a method, so-called molding, in which an optical glass on which a phase structure is obtained by making a replica of a mold (die) on which a phase structure is formed. Incidentally, either of the following methods may be employed as a method for making a mold on which a phase structure is formed: a method in which a phase structure is formed by repeating the processes for photo-lithography and etching, and a method in which a phase structure is machined with a precision lathe.

In the aforesaid invention, the followings are preferable ranges for wavelengths λ1, λ2 and λ3 and for protective layer thicknesses t1, t2 and t3.
350 nm≦λ1≦450 nm
600 nm≦λ2≦700 nm
750 nm≦λ3≦850 nm
0.0 mm≦t1≦0.7 mm
0.4 mm≦t2≦0.7 mm
0.9 mm≦t3≦1.3 mm

Incidentally, the followings are a more preferable range for each of them is as follows.
390 nm≦λ1≦415 nm
635 nm≦λ2≦670 nm
770 nm≦λ3≦810 nm
0.5 mm≦t1≦0.7 mm
0.5 mm≦t2≦0.7 mm
1.1 mm≦t3≦1.3 mm

Next, an example of the optical pickup apparatus including the coupling lens shown in the aforesaid embodiment will be explained.

### Example 1

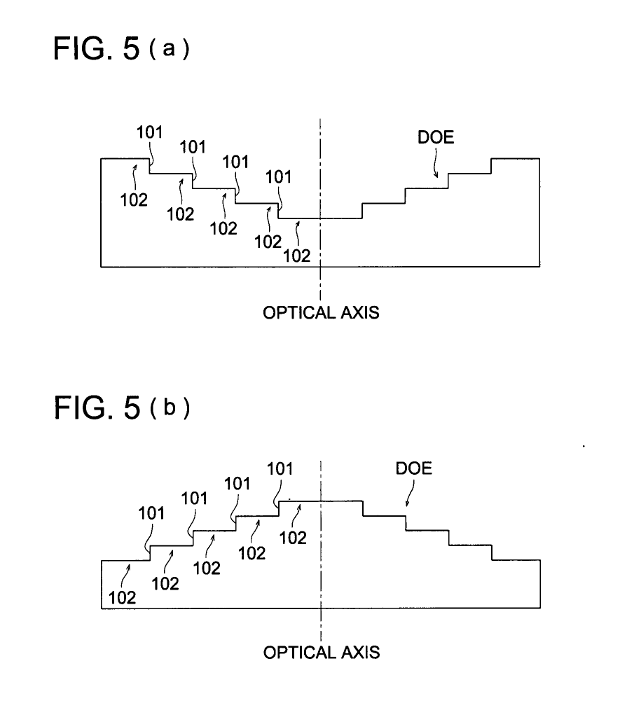

As shown in FIG. 9, the coupling lens of the present example is provided with the first lens portion L1 and the second lens portion L2, which are layered in this order from the light source side. In the coupling lens, diffractive structure DOE is formed, as the first phase structure, on a boundary surface between the first lens portion and the second lens portion. In the coupling lens, diffractive structure DOE is further formed, as the second phase structure, on a boundary surface between the second lens portion and an air space.

Table 1 shows lens data of Example 1.

TABLE 1
Example 1 Lens data

| | | | |
|---|---|---|---|
| Total optical system magnification | m_{T1}: 6.8 | m_{T2}: 6.8 | m_{T3}: 7.4 |
| Focal length of coupling lens | f_{CU1} = 18.2 mm | f_{CU2} = 19.8 mm | f_{CU3} = 30.1 mm |
| Optical system magnification of coupling lens | m_{CU1}: −0.228 | m_{CU2}: −0.131 | m_{CU3}: 0.239 |
| Focal length of objective lens | f_{OBJ1} = 3.2 mm | f_{OBJ2} = 3.29 mm | f_{OBJ3} = 3.27 mm |
| Numerical aperture on image side of objective lens | NA_{OBJ1}: 0.65 | NA_{OBJ2}: 0.65 | NA_{OBJ3}: 0.51 |
| Optical system magnification of objective lens | m_{OBJ1}: 1/30.03 | m_{OBJ2}: 1/51.81 | m_{OBJ3}: −1/31.15 |

| i^{th} surface | ri | di(407 nm) | ni(407 nm) | di(655 nm) | ni(655 nm) | di(785 nm) | ni(785 nm) |
|---|---|---|---|---|---|---|---|
| 0 | | 0.00 | | 0.00 | | 0.00 | |
| 1 | ∞ | 6.25 | 1.5299 | 6.25 | 1.5144 | 6.25 | 1.5111 |
| 2 | ∞ | 17.42 | 1.0 | 17.42 | 1.0 | 17.42 | 1.0 |
| 3 | 71.694 | 1.70 | 1.6365 | 1.70 | 1.5919 | 1.70 | 1.5845 |
| 4 | ∞ | 1.00 | 1.5598 | 1.00 | 1.5407 | 1.00 | 1.5372 |
| 5 | −17.410 | 1.00 | 1.0 | 1.00 | 1.0 | 1.00 | 1.0 |
| 6 | ∞ | 2.80 | 1.0 | 2.80 | 1.0 | 2.80 | 1.0 |
| 7 | ∞ | 5.00 | 1.0 | 5.00 | 1.0 | 5.00 | 1.0 |
| 8 | ∞ | 0.01 | | 0.01 | | 0.01 | |
| (Aperture | | (φ3.901 mm) | | (φ4.082 mm) | | (φ3.389 mm) | |
| diameter) | | | | | | | |
| 9 | 1.9846 | 1.65 | 1.5819 | 1.65 | 1.5860 | 1.65 | 1.5819 |
| 10 | −23.4721 | 1.65 | 1.0 | 1.77 | 1.0 | 1.57 | 1.0 |
| 11 | ∞ | 0.6 | 1.6187 | 0.6 | 1.5775 | 1.2 | 1.5706 |
| 12 | ∞ | | | | | | |

*di represents displacement from i^{th} surface to (i + 1)^{th} surface.

Aspheric surface data
4^{th} surface
Optical path difference function
(HD DVD: 0^{th} order, DVD: 0^{th} order, CD: 1^{st} order,
manufacture wavelength 785 nm)

| | |
|---|---|
| C2 | 1.0042E−02 |
| C4 | −2.1156E−05 |

5^{th} surface
Aspheric surface coefficient

| | |
|---|---|
| κ | −9.9356E−01 |
| A4 | −1.2548E−05 |

Optical path difference function
(HD DVD: 2^{nd} order, DVD: 1^{st} order, CD: 1^{st} order,
manufacture wavelength 407 nm)

| | |
|---|---|
| C2 | −3.5838E−03 |
| C4 | 5.2504E−06 |

9^{th} surface
Aspheric surface coefficient

| | |
|---|---|
| κ | −6.2316E−01 |
| A4 | 3.5193E−03 |
| A6 | −8.8455E−04 |
| A8 | 1.1392E−03 |
| A10 | −4.4959E−04 |
| A12 | 9.5050E−05 |
| A14 | −8.3859E−06 |

10^{th} surface
Aspheric surface coefficient

| | |
|---|---|
| κ | −1.1584E+03 |
| A4 | −2.3693E−03 |
| A6 | 7.4703E−03 |
| A8 | −4.4122E−03 |
| A10 | 1.3821E−03 |
| A12 | −2.3560E−04 |
| A14 | 1.6617E−05 |

As shown in Table 1, the coupling lens of the present example is compatible for HD, DVD and CD, and it is established to have focal length f_{CU1} of 18.2 mm and magnification m_{CU1} of −0.228 for wavelength λ1 of 407 nm, focal length f_{CU2} of 19.80 mm and magnification m_{CU2} of −0.131 for wavelength λ2 of 655 nm, and focal length f_{CU3} of 30.1 mm and magnification m_{CU3} of 0.239 for wavelength λ3 of 785 nm.

Material A forming first lens portion L1 is established to have refractive index nd of 1.598 for d line and Abbe number νd of 28.0 for d line, while, material B forming the second lens portion L2 is established to have refractive index nd of 1.5435 for d line and Abbe number νd of 56.7 for d line.

Further, each of an incident surface (third surface) of the first lens portion and a boundary surface (fourth surface) between the first lens portion and the second lens portion is constituted with a flat surface, and each of an emitting surface (fifth surface) of the second lens portion, an incident surface (ninth surface), and an emitting surface (tenth surface) of an objective optical element is formed to be an aspheric surface that is prescribed by a numerical expression wherein coefficients shown in Table 1 are substituted in the following expression (Numeral 1), and is symmetrical with respect to optical axis L.

$$Aspheric surface form expression \\ x ( h ) = \frac{{h}^{2} / r}{1 + \sqrt{1 - ( 1 + κ ) {( h / r )}^{2}}} + {\sum }_{i = 2} {A}_{2 i} {h}^{2 i} \qquad ( Numeral 1 )$$

In the aforesaid expression, X(h) represents an axis in the optical axis direction (light traveling direction is positive), κ represents a conic constant, A₂ᵢ represents an aspheric surface coefficient, h (mm) represents a height in the direction perpendicular to the optical axis and r represents a radius of curvature.

Further, diffractive structure HOE is formed on the fourth surface and diffractive structure DOE is formed on the fifth surface. Each diffractive structure is expressed by an optical path length which is added to the wavefront by this structure. This optical path length is expressed by optical path difference function φ(h) (mm) defined by substituting coefficients shown in Table 1 in the following expression of Numeral 2.

$$ϕ ( h ) = λ / {λ}_{B} \times n \times {\sum }_{i = 1} {C}_{2 i} {h}^{2 i} \qquad ( Numeral 2 )$$

### Example 2

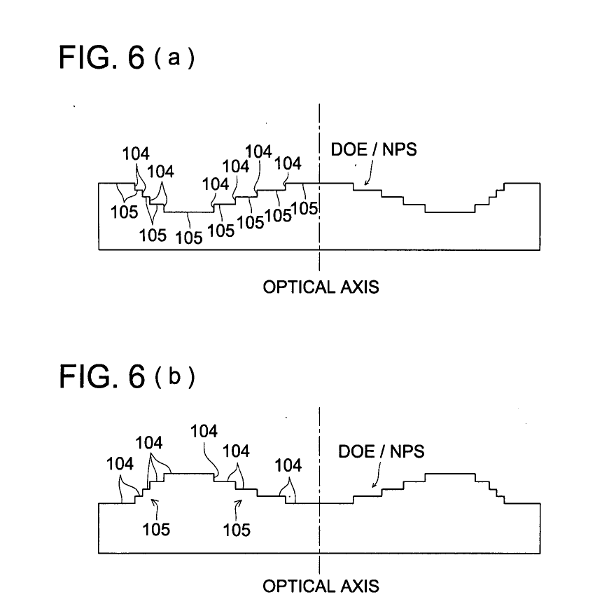

As shown in FIG. 10, the coupling lens of the present example is provided with the first lens portion L1 and the second lens portion L2 which are layered in this order from the light source side. In the coupling lens, diffractive structure HOE is formed, as the first phase structure, on a boundary surface between the first lens portion and the second lens portion. In the coupling lens, diffractive structure DOE is further formed, as the second phase structure, on a boundary surface between the second lens portion and an air space.

Table 2 shows lens data of Example 2.

TABLE 2
Example 2 Lens data

| | | | |
|---|---|---|---|
| Total optical system magnification | m_{T1}: 6.9 | m_{T2}: 6.8 | m_{T3}: 7.4 |
| Focal length of coupling lens | f_{CU1} = 18.2 mm | f_{CU2} = 19.8 mm | f_{CU3} = 30.2 mm |
| Optical system magnification of coupling lens | m_{CU1}: −0.229 | m_{CU2}: −0.131 | m_{CU3}: 0.239 |
| Focal length of objective lens | f_{OBJ1} = 3.2 mm | f_{OBJ2} = 3.29 mm | f_{OBJ3} = 3.27 mm |
| Numerical aperture on image side of objective lens | NA_{OBJ1}: 0.65 | NA_{OBJ2}: 0.65 | NA_{OBJ3}: 0.51 |
| Optical system magnification of objective lens | m_{OBJ1}: 1/30.03 | m_{OBJ2}: 1/51.81 | m_{OBJ3}: −1/31.15 |

| i^{th} surface | ri | di(407 nm) | ni(407 nm) | di(655 nm) | ni(655 nm) | di(785 nm) | ni(785 nm) |
|---|---|---|---|---|---|---|---|
| 0 | | 0.00 | | 0.00 | | 0.00 | |
| 1 | ∞ | 6.25 | 1.5299 | 6.25 | 1.5144 | 6.25 | 1.5111 |
| 2 | ∞ | 17.25 | 1.0 | 17.25 | 1.0 | 17.25 | 1.0 |
| 3 | ∞ | 0.10 | 1.6365 | 0.10 | 1.5919 | 0.10 | 1.5845 |
| 4 | ∞ | 1.50 | 1.5598 | 1.50 | 1.5407 | 1.50 | 1.5372 |
| 5 | −14.433 | 1.00 | 1.0 | 1.00 | 1.0 | 1.00 | 1.0 |
| 6 | ∞ | 2.80 | 1.0 | 2.80 | 1.0 | 2.80 | 1.0 |
| 7 | ∞ | 5.00 | 1.0 | 5.00 | 1.0 | 5.00 | 1.0 |
| 8 | ∞ | 0.01 | | 0.01 | | 0.01 | |
| (Aperture | | (φ3.901 mm) | | (φ4.082 mm) | | (φ3.389 mm) | |
| diameter) | | | | | | | |
| 9 | 1.9846 | 1.65 | 1.5819 | 1.65 | 1.5860 | 1.65 | 1.5819 |
| 10 | −23.4721 | 1.65 | 1.0 | 1.77 | 1.0 | 1.57 | 1.0 |
| 11 | ∞ | 0.6 | 1.6187 | 0.6 | 1.5775 | 1.2 | 1.5706 |
| 12 | ∞ | | | | | | |

*di represent displacement from i^{th} surface to (i + 1)^{th} surface.

Aspheric surface data
4^{th} surface
Optical path difference function
(HD DVD: 0^{th} order, DVD: 0^{th} order, CD: 1^{st} order,
manufacture wavelength 785 nm)

| | |
|---|---|
| C2 | 1.0400E−02 |
| C4 | −2.9476E−05 |

5^{th} surface
Aspheric surface coefficient

| | |
|---|---|
| κ | −5.3306E−01 |
| A4 | −1.8418E−05 |

Optical path difference function
(HD DVD: 2^{nd} order, DVD: 1^{st} order, CD: 1^{st} order,
manufacture wavelength 407 nm)

| | |
|---|---|
| C2 | −4.0394E−03 |
| C4 | 5.2138E−06 |

9^{th} surface
Aspheric surface coefficient

| | |
|---|---|
| κ | −6.2316E−01 |
| A4 | 3.5193E−03 |
| A6 | −8.8455E−04 |
| A8 | 1.1392E−03 |
| A10 | −4.4959E−04 |
| A12 | 9.5050E−05 |
| A14 | −8.3859E−06 |

10^{th} surface
Aspheric surface coefficient

| | |
|---|---|
| κ | −1.1584E+03 |
| A4 | −2.3693E−03 |
| A6 | 7.4703E−03 |
| A8 | −4.4122E−03 |
| A10 | 1.3821E−03 |
| A12 | −2.3560E−04 |
| A14 | 1.6617E−05 |

As shown in Table 2, the coupling lens of the present example is compatible for HD, DVD and CD, and it is established to have focal length f_{CU1} of 18.2 mm and magnification m_{CU1} of −0.229 for wavelength λ1 of 407 nm, focal length f_{CU2} of 19.80 mm and magnification m_{CU2} of −0.131 for wavelength λ2 of 655 nm, and focal length f_{CU3} of 30.2 mm and magnification m_{CU3} of 0.239 for wavelength λ3 of 785 nm.

Material A forming the first lens portion L1 is established to have refractive index nd of 1.598 for d line and Abbe number νd of 28.0 for d line, while, material B forming the second lens portion L2 is established to have refractive index nd of 1.5435 for d line and Abbe number νd of 56.7 for d line.

Further, each of an incident surface (third surface) of the first lens portion and a boundary surface (fourth surface) between the first lens portion and the second lens portion is constituted with a flat surface, and each of an emitting surface (fifth surface) of the second lens portion, an incident surface (ninth surface) and an emitting surface (tenth surface) of an objective optical element is formed to be an aspheric surface.

Further, diffractive structure HOE is formed on the fourth surface and diffractive structure DOE is formed on the fifth surface.

### Example 3

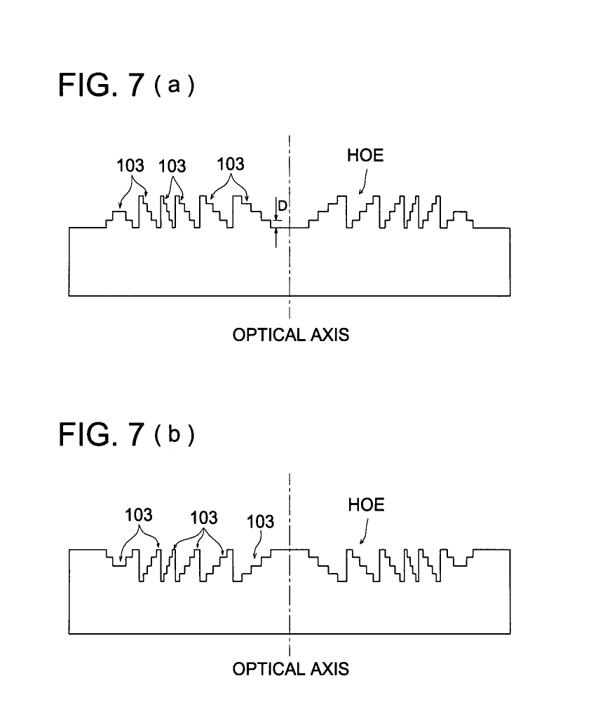

As shown in FIG. 11, the coupling lens of the present example is provided with the first lens portion L1 and the second lens portion L2 which are layered in this order from the light source side. In the coupling lens, diffractive structure HOE is formed, as the first phase structure, on a boundary surface between the first lens portion and the second lens portion. In the coupling lens, diffractive structure DOE is further formed, as the second phase structure, on a boundary surface between the second lens portion and an air space.

Table 3 shows lens data of Example 3.

TABLE 3
Example 3 Lens data

| | | | |
|---|---|---|---|
| Total optical system magnification | m_{T1}: 6.9 | m_{T2}: 6.8 | m_{T3}: 7.4 |
| Focal length of coupling lens | f_{CU1} = 18.2 mm | f_{CU2} = 19.9 mm | f_{CU3} = 29.5 mm |
| Optical system magnification of coupling lens | m_{CU1}: −0.227 | m_{CU2}: −0.132 | m_{CU3}: 0.237 |
| Focal length of objective lens | f_{OBJ1} = 3.2 mm | f_{OBJ2} = 3.29 mm | f_{OBJ3} = 3.27 mm |
| Numerical aperture on image side of objective lens | NA_{OBJ1}: 0.65 | NA_{OBJ2}: 0.65 | NA_{OBJ3}: 0.51 |
| Optical system magnification of objective lens | m_{OBJ1}: 1/30.03 | m_{OBJ2}: 1/51.81 | m_{OBJ3}: −1/31.15 |

| i^{th} surface | ri | di(407 nm) | ni(407 nm) | di(655 nm) | ni(655 nm) | di(785 nm) | ni(785 nm) |
|---|---|---|---|---|---|---|---|
| 0 | | 0.00 | | 0.00 | | 0.00 | |
| 1 | ∞ | 6.25 | 1.5299 | 6.25 | 1.5144 | 6.25 | 1.5111 |
| 2 | ∞ | 17.71 | 1.0 | 17.71 | 1.0 | 17.71 | 1.0 |
| 3 | 14.638 | 0.50 | 1.6365 | 0.50 | 1.5919 | 0.50 | 1.5845 |
| 4 | ∞ | 1.30 | 1.5598 | 1.30 | 1.5407 | 1.30 | 1.5372 |
| 5 | −6.0720 | 1.00 | 1.0 | 1.00 | 1.0 | 1.00 | 1.0 |
| 6 | ∞ | 2.80 | 1.0 | 2.80 | 1.0 | 2.80 | 1.0 |
| 7 | ∞ | 5.00 | 1.0 | 5.00 | 1.0 | 5.00 | 1.0 |
| 8 | ∞ | 0.01 | | 0.01 | | 0.01 | |
| (Aperture | | (φ3.901 mm) | | (φ4.082 mm) | | (φ3.389 mm) | |
| diameter) | | | | | | | |
| 9 | 1.9846 | 1.65 | 1.5819 | 1.65 | 1.5860 | 1.65 | 1.5819 |
| 10 | −23.4721 | 1.65 | 1.0 | 1.77 | 1.0 | 1.57 | 1.0 |
| 11 | ∞ | 0.6 | 1.6187 | 0.6 | 1.5775 | 1.2 | 1.5706 |
| 12 | ∞ | | | | | | |

*di represents displacement from i^{th} surface to (i + 1)^{th} surface.

Aspheric surface data
3^{rd} surface
Aspheric surface coefficient

| | |
|---|---|
| κ | −1.0686E+00 |
| A4 | −6.3041E−05 |

4^{th} surface
Optical path difference function
(HD DVD: 1^{st} order, DVD: 1^{st} order, CD: 1^{st} order,
manufacture wavelength 530 nm)

| | |
|---|---|
| C2 | 1.1731E−02 |
| C4 | −4.3708E−05 |

5^{th} surface
Aspheric surface coefficient

| | |
|---|---|
| κ | −1.0002E+00 |
| A4 | 5.9391E−05 |

Optical path difference function
(HD DVD: 2^{nd} order, DVD: 1^{st} order, CD: 1^{st} order,
manufacture wavelength 407 nm)

| | |
|---|---|
| C2 | 1.5475E−02 |
| C4 | −1.9989E−06 |

9^{th} surface
Aspheric surface coefficient

| | |
|---|---|
| κ | −6.2316E−01 |
| A4 | 3.5193E−03 |
| A6 | −8.8455E−04 |
| A8 | 1.1392E−03 |
| A10 | −4.4959E−04 |
| A12 | 9.5050E−05 |
| A14 | −8.3859E−06 |

10^{th} surface
Aspheric surface coefficient

| | |
|---|---|
| κ | −1.1584E+03 |
| A4 | −2.3693E−03 |
| A6 | 7.4703E−03 |
| A8 | −4.4122E−03 |
| A10 | 1.3821E−03 |
| A12 | −2.3560E−04 |
| A14 | 1.6617E−05 |

As shown in Table 3, the coupling lens of the present example is compatible for HD, DVD and CD, and it is established to have focal length f_{CU1} of 18.2 mm and magnification m_{CU1} of −0.227 for wavelength λ1 of 407 nm, focal length f_{CU2} of 19.90 mm and magnification m_{CU2} of −0.132 for wavelength λ2 of 655 nm, and focal length f_{CU3} of 29.5 mm and magnification m_{CU3} of 0.237 for wavelength λ3 of 785 nm.

Material A forming the first lens portion L1 is established to have refractive index nd of 1.598 for d line and Abbe number νd of 28.0 for d line, while, material B forming the second lens portion L2 is established to have refractive index nd of 1.5435 for d line and Abbe number νd of 56.7 for d line.

Further, a boundary surface (fourth surface) between the first lens portion and the second lens portion is constituted with a flat surface, and each of an incident surface (third surface) of the first lens portion, an emitting surface (fifth surface) of the second lens portion, an incident surface (ninth surface) and an emitting surface (tenth surface) of an objective optical element is formed to be an aspheric surface.

Further, diffractive structure DOE is formed on the fourth surface and diffractive structure DOE is formed on the fifth surface.

### Example 4

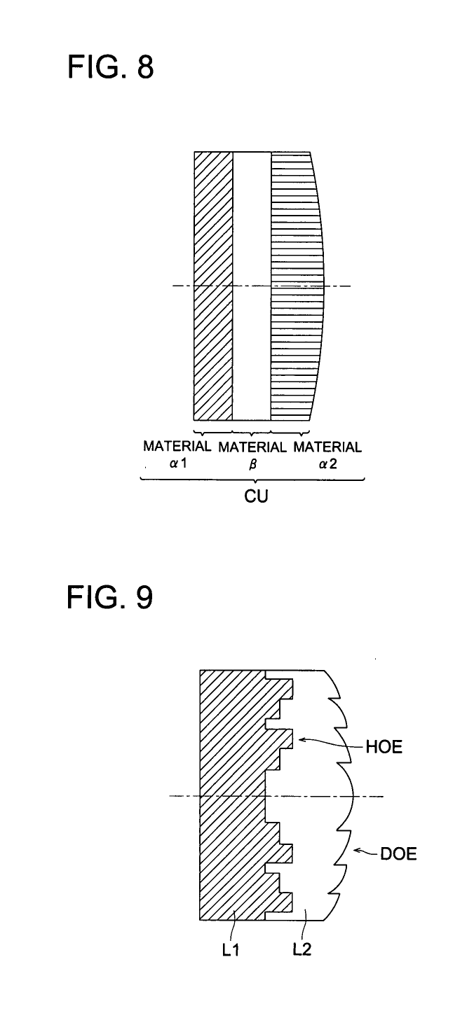

As shown in FIG. 12, the coupling lens of the present example is provided with the first lens portion L1 and the second lens portion L2 which are layered in this order from the light source side. In the coupling lens, diffractive structure DOE is formed, as the first phase structure, on a boundary surface between the first lens portion and the second lens portion. In the coupling lens, diffractive structure DOE is further formed, as the second phase structure, on a boundary surface between the second lens portion and an air space.

Table 4 shows lens data of Example 4.

TABLE 4
Example 4 Lens data

| | | | |
|---|---|---|---|
| Total optical system magnification | m_{T1}: 6.8 | m_{T2}: 6.8 | m_{T3}: 7.4 |
| Focal length of coupling lens | f_{CU1} = 18.2 mm | f_{CU2} = 19.9 mm | f_{CU3} = 29.5 mm |
| Optical system magnification of coupling lens | m_{CU1}: −0.227 | m_{CU2}: −0.132 | m_{CU3}: 0.237 |
| Focal length of objective lens | f_{OBJ1} = 3.2 mm | f_{OBJ2} = 3.29 mm | f_{OBJ3} = 3.27 mm |
| Numerical aperture on image side of objective lens | NA_{OBJ1}: 0.65 | NA_{OBJ2}: 0.65 | NA_{OBJ3}: 0.51 |
| Optical system magnification of objective lens | m_{OBJ1}: 1/30.03 | m_{OBJ2}: 1/51.81 | m_{OBJ3}: −1/31.15 |

| i^{th} surface | ri | di(407 nm) | ni(407 nm) | di(655 nm) | ni(655 nm) | di(785 nm) | ni(785 nm) |
|---|---|---|---|---|---|---|---|
| 0 | | 0.00 | | 0.00 | | 0.00 | |
| 1 | ∞ | 6.25 | 1.5299 | 6.25 | 1.5144 | 6.25 | 1.5111 |
| 2 | ∞ | 17.68 | 1.0 | 17.68 | 1.0 | 17.68 | 1.0 |
| 3 | 16.812 | 0.50 | 1.6365 | 0.50 | 1.5919 | 0.50 | 1.5845 |
| 4 | −17.144 | 1.30 | 1.5598 | 1.30 | 1.5407 | 1.30 | 1.5372 |
| 5 | −5.9832 | 1.00 | 1.0 | 1.00 | 1.0 | 1.00 | 1.0 |
| 6 | ∞ | 2.80 | 1.0 | 2.80 | 1.0 | 2.80 | 1.0 |
| 7 | ∞ | 5.00 | 1.0 | 5.00 | 1.0 | 5.00 | 1.0 |
| 8 | ∞ | 0.01 | | 0.01 | | 0.01 | |
| (Aperture | | (φ3.901 mm) | | (φ4.082 mm) | | (φ3.389 mm) | |
| diameter) | | | | | | | |
| 9 | 1.9846 | 1.65 | 1.5819 | 1.65 | 1.5860 | 1.65 | 1.5819 |
| 10 | −23.4721 | 1.65 | 1.0 | 1.77 | 1.0 | 1.57 | 1.0 |
| 11 | ∞ | 0.6 | 1.6187 | 0.6 | 1.5775 | 1.2 | 1.5706 |
| 12 | ∞ | | | | | | |

*di represents displacement from i^{th} surface to (i + 1)^{th} surface.

Aspheric surface data
3^{rd} surface
Aspheric surface coefficient

| | |
|---|---|
| κ | −9.9233E−01 |
| A4 | −4.9408E−05 |

4^{th} surface
Optical path difference function
(HD DVD: 1^{st} order, DVD: 1^{st} order, CD: 1^{st} order,
manufacture wavelength 530 nm)

| | |
|---|---|
| C2 | 1.0857E−02 |
| C4 | −3.3263E−05 |

5^{th} surface
Aspheric surface coefficient

| | |
|---|---|
| κ | −1.0050E+00 |
| A4 | 4.8643E−05 |

Optical path difference function
(HD DVD: 2^{nd} order, DVD: 1^{st} order, CD: 1^{st} order,
manufacture wavelength 407 nm)

| | |
|---|---|
| C2 | 1.5854E−02 |
| C4 | 1.4888E−06 |

9^{th} surface
Aspheric surface coefficient

| | |
|---|---|
| κ | −6.2316E−01 |
| A4 | 3.5193E−03 |
| A6 | −8.8455E−04 |
| A8 | 1.1392E−03 |
| A10 | −4.4959E−04 |
| A12 | 9.5050E−05 |
| A14 | −8.3859E−06 |

10^{th} surface
Aspheric surface coefficient

| | |
|---|---|
| κ | −1.1584E+03 |
| A4 | −2.3693E−03 |
| A6 | 7.4703E−03 |
| A8 | −4.4122E−03 |
| A10 | 1.3821E−03 |
| A12 | −2.3560E−04 |
| A14 | 1.6617E−05 |

As shown in Table 4, the coupling lens of the present example is compatible for HD, DVD and CD, and it is established to have focal length f_{CU1} of 18.2 mm and magnification m_{CU1} of −0.227 for wavelength λ1 of 407 nm, focal length f_{CU2} of 19.90 mm and magnification m_{CU2} of −0.132 for wavelength λ2 of 655 nm, and focal length f_{CU3} of 29.5 mm and magnification m_{CU3} of 0.237 for wavelength λ3 of 785 nm.

Material A forming the first lens portion L1 is established to have refractive index nd of 1.598 for d line and Abbe number νd of 28.0 for d line, while, material B forming the second lens portion L2 is established to have refractive index nd of 1.5435 for d line and Abbe number νd of 56.7 for d line.

Further, a boundary surface (fourth surface) between the first lens portion and the second lens portion is constituted with a flat surface, and each of an incident surface (third surface) of the first lens portion, an emitting surface (fifth surface) of the second lens portion, an incident surface (ninth surface) and an emitting surface (tenth surface) of an objective optical element is formed to be an aspheric surface.

Further, diffractive structure DOE is formed on the fourth surface and diffractive structure DOE is formed on the fifth surface.

### Example 5

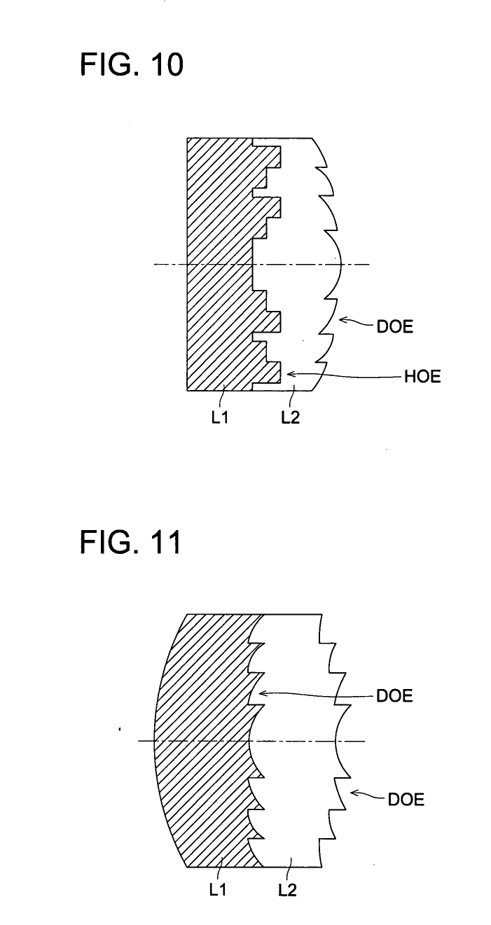

As shown in FIG. 13, the coupling lens of the present example is provided with the first lens portion L1 and the second lens portion L2 which are layered in this order from the light source side. In the coupling lens, diffractive structure HOE is formed, as the first phase structure, on a boundary surface between the first lens portion and an air space. In the coupling lens, diffractive structure DOE is further formed, as the second phase structure, on a boundary surface between the second lens portion and an air space.

Table 5 shows lens data of Example 5.

TABLE 5
Example 5 Lens data

| | | | |
|---|---|---|---|
| Total optical system magnification | m_{T1}: 6.9 | m_{T2}: 6.8 | m_{T3}: 6.7 |
| Focal length of coupling lens | f_{CU1} = 18.2 mm | f_{CU2} = 19.8 mm | f_{CU3} = 30.3 mm |
| Optical system magnification of coupling lens | m_{CU1}: −0.227 | m_{CU2}: −0.131 | m_{CU3}: 0.239 |
| Focal length of objective lens | f_{OBJ1} = 3.2 mm | f_{OBJ2} = 3.29 mm | f_{OBJ3} = 3.27 mm |
| Numerical aperture on image side of objective lens | NA_{OBJ1}: 0.65 | NA_{OBJ2}: 0.65 | NA_{OBJ3}: 0.51 |
| Optical system magnification of objective lens | m_{OBJ1}: 1/30.03 | m_{OBJ2}: 1/51.81 | m_{OBJ3}: −1/31.15 |

| i^{th} surface | ri | di(407 nm) | ni(407 nm) | di(655 nm) | ni(655 nm) | di(785 nm) | ni(785 nm) |
|---|---|---|---|---|---|---|---|
| 0 | | 0.00 | | 0.00 | | 0.00 | |
| 1 | ∞ | 6.25 | 1.5299 | 6.25 | 1.5144 | 6.25 | 1.5111 |
| 2 | ∞ | 17.25 | 1.0 | 17.25 | 1.0 | 17.25 | 1.0 |
| 3 | ∞ | 0.10 | 1.6365 | 0.10 | 1.5919 | 0.10 | 1.5845 |
| 4 | ∞ | 1.50 | 1.5598 | 1.50 | 1.5407 | 1.50 | 1.5372 |
| 5 | −14.433 | 1.00 | 1.0 | 1.00 | 1.0 | 1.00 | 1.0 |
| 6 | ∞ | 2.80 | 1.0 | 2.80 | 1.0 | 2.80 | 1.0 |
| 7 | ∞ | 5.00 | 1.0 | 5.00 | 1.0 | 5.00 | 1.0 |
| 8 | ∞ | 0.01 | | 0.01 | | 0.01 | |
| (Aperture | | (φ3.901 mm) | | (φ4.082 mm) | | (φ3.389 mm) | |
| diameter) | | | | | | | |
| 9 | 1.9846 | 1.65 | 1.5819 | 1.65 | 1.5860 | 1.65 | 1.5819 |
| 10 | −23.4721 | 1.65 | 1.0 | 1.77 | 1.0 | 1.57 | 1.0 |
| 11 | ∞ | 0.6 | 1.6187 | 0.6 | 1.5775 | 1.2 | 1.5706 |
| 12 | ∞ | | | | | | |

*di represents displacement from i^{th} surface to (i + 1)^{th} surface.

Aspheric surface data
3^{rd} surface
Optical path difference function
(HD DVD: 0^{th} order, DVD: 0^{th} order, CD: 1^{st} order,
manufacture wavelength 785 nm)

| | |
|---|---|
| C2 | 1.0475E−02 |
| C4 | −2.9984E−05 |

5^{th} surface
Aspheric surface coefficient

| | |
|---|---|
| κ | −5.3084E−01 |
| A4 | −1.8316E−05 |

Optical path difference function
(HD DVD: 2^{nd} order, DVD: 1^{st} order, CD: 1^{st} order,
manufacture wavelength 407 nm)

| | |
|---|---|
| C2 | −4.0394E−03 |
| C4 | 5.2119E−06 |

9^{th} surface
Aspheric surface coefficient

| | |
|---|---|
| κ | −6.2316E−01 |
| A4 | 3.5193E−03 |
| A6 | −8.8455E−04 |
| A8 | 1.1392E−03 |
| A10 | −4.4959E−04 |
| A12 | 9.5050E−05 |
| A14 | −8.3859E−06 |

10^{th} surface
Aspheric surface coefficient

| | |
|---|---|
| κ | −1.1584E+03 |
| A4 | −2.3693E−03 |
| A6 | 7.4703E−03 |
| A8 | −4.4122E−03 |
| A10 | 1.3821E−03 |
| A12 | −2.3560E−04 |
| A14 | 1.6617E−05 |

As shown in Table 5, the coupling lens of the present example is compatible for HD, DVD and CD, and it is established to have focal length f_{CU1} of 18.2 mm and magnification m_{CU1} of −0.227 for wavelength λ1 of 407 nm, focal length f_{CU2} of 19.80 mm and magnification m_{CU2} of −0.131 for wavelength λ2 of 655 nm, and focal length f_{CU3} of 30.3 mm and magnification m_{CU3} of 0.239 for wavelength λ3 of 785 nm.

Material A forming the first lens portion L1 is established to have refractive index nd of 1.598 for d line and Abbe number νd of 28.0 for d line, while, material B forming the second lens portion L2 is established to have refractive index nd of 1.5435 for d line and Abbe number νd of 56.7 for d line.

Further, each of an incident surface (third surface) of the first lens portion and a boundary surface (fourth surface) between the first lens portion and the second lens portion is constituted with a flat surface, and each of an emitting surface (fifth surface) of the second lens portion, an incident surface (ninth surface) and an emitting surface (tenth surface) of an objective optical element is formed to be an aspheric surface.

Further, diffractive structure HOE is formed on the third surface and diffractive structure DOE is formed on the fourth surface.

### Example 6

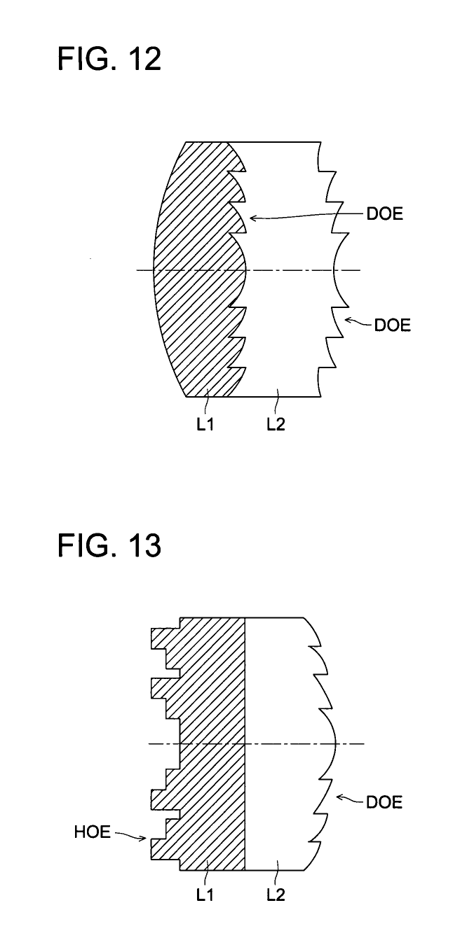

As shown in FIG. 14, the coupling lens of the present example is provided with the first lens portion L1 and the second lens portion L2 which are layered in this order from the light source side. In the coupling lens, diffractive structure HOE is formed, as the first phase structure, on a boundary surface between the first lens portion and the second lens portion.

Table 6 shows lens data of Example 6.

TABLE 6
Example 6 Lens data

| | | | |
|---|---|---|---|
| Total optical system magnification | m_{T1}: 6.3 | m_{T2}: 6.2 | m_{T3}: 6.7 |
| Focal length of coupling lens | f_{CU1} = 17.0 mm | f_{CU2} = 17.5 mm | f_{CU3} = 25.0 mm |
| Optical system magnification of coupling lens | m_{CU1}: −0.210 | m_{CU2}: −0.179 | m_{CU3}: 0.173 |
| Focal length of objective lens | f_{OBJ1} = 3.1 mm | f_{OBJ2} = 3.18 mm | f_{OBJ3} = 3.22 mm |
| Numerical aperture on image side of objective lens | NA_{OBJ1}: 0.65 | NA_{OBJ2}: 0.65 | NA_{OBJ3}: 0.51 |
| Optical system magnification of objective lens | m_{OBJ1}: 1/30.3 | m_{OBJ2}: 1/34.6 | m_{OBJ3}: −1/38.8 |

| i^{th} surface | ri | di(407 nm) | ni(407 nm) | di(655 nm) | ni(655 nm) | di(785 nm) | ni(785 nm) |
|---|---|---|---|---|---|---|---|
| 0 | | 0.00 | | 0.00 | | 0.00 | |
| 1 | ∞ | 6.25 | 1.5299 | 6.25 | 1.5144 | 6.25 | 1.5111 |
| 2 | ∞ | 15.82 | 1.0 | 17.25 | 1.0 | 17.25 | 1.0 |
| 3 | 30.666 | 1.00 | 1.6365 | 0.10 | 1.5919 | 0.10 | 1.5845 |
| 4 | 21.083 | 0.60 | 1.5598 | 1.50 | 1.5407 | 1.50 | 1.5372 |
| 5 | −13.199 | 1.00 | 1.0 | 1.00 | 1.0 | 1.00 | 1.0 |
| 6 | ∞ | 2.80 | 1.0 | 2.80 | 1.0 | 2.80 | 1.0 |
| 7 | ∞ | 5.00 | 1.0 | 5.00 | 1.0 | 5.00 | 1.0 |
| 8 | ∞ | 0.01 | | 0.01 | | 0.01 | |
| (Aperture | | (φ3.901 mm) | | (φ4.082 mm) | | (φ3.389 mm) | |
| diameter) | | | | | | | |
| 9 | 2.0744 | 1.65 | 1.5819 | 1.65 | 1.5860 | 1.65 | 1.5819 |
| 10 | −27.171 | 1.59 | 1.0 | 1.67 | 1.0 | 1.50 | 1.0 |
| 11 | ∞ | 0.6 | 1.6187 | 0.6 | 1.5775 | 1.2 | 1.5706 |
| 12 | ∞ | | | | | | |

*di represents displacement from i^{th} surface to (i + 1)^{th} surface.

Aspheric surface data
4^{th} surface
Optical path difference function
(HD DVD: 0^{th} order, DVD: 0^{th} order, CD: 1^{st} order,
manufacture wavelength 785 nm)

| | |
|---|---|
| C2 | 8.6429E−03 |
| C4 | −2.9014E−05 |

5^{th} surface
Aspheric surface coefficient

| | |
|---|---|
| κ | −1.0019E+00 |
| A4 | 2.9279E−05 |

9^{th} surface
Aspheric surface coefficient

| | |
|---|---|
| κ | −6.1678E−01 |
| A4 | 4.1890E−03 |
| A6 | −1.3000E−03 |
| A8 | 9.6031E−04 |
| A10 | −2.9440E−04 |
| A12 | 4.7955E−05 |
| A14 | −4.7441E−06 |

Optical path difference function
(HD DVD: 6^{th} order, DVD: 4^{th} order, CD: 3^{rd} order,
manufacture wavelength 407 nm)

| | |
|---|---|
| C2 | −1.3376E−03 |
| C4 | −1.4671E−04 |
| C6 | 1.1345E−05 |
| C8 | 2.0565E−07 |
| C10 | −8.0566E−07 |

10^{th} surface
Aspheric surface coefficient

| | |
|---|---|
| κ | −4.3483E+03 |
| A4 | 4.1317E−04 |
| A6 | 4.8894E−03 |
| A8 | −3.2631E−03 |
| A10 | 8.7862E−04 |
| A12 | −1.1924E−04 |
| A14 | 6.2985E−06 |

As shown in Table 6, the coupling lens of the present example is compatible for HD, DVD and CD, and it is established to have focal length f_{CU1} of 17.0 mm and magnification m_{CU1} of −0.210 for wavelength λ1 of 407 nm, focal length f_{CU2} of 17.50 mm and magnification m_{CU2} of −0.179 for wavelength λ2 of 655 nm, and focal length f_{CU3} of 25.0 mm and magnification m_{CU3} of 0.173 for wavelength λ3 of 785 nm.

Material A forming the first lens portion L1 is established to have refractive index nd of 1.598 for d line and Abbe number νd of 28.0 for d line, while, material B forming the second lens portion L2 is established to have refractive index nd of 1.5435 for d line and Abbe number νd of 56.7 for d line.

Further, each of an incident surface (third surface) of the first lens portion and a boundary surface (fourth surface) between the first lens portion and the second lens portion is constituted with a flat surface, and each of an emitting surface (fifth surface) of the second lens portion, an incident surface (ninth surface) and an emitting surface (tenth surface) of an objective optical element is formed to be an aspheric surface.

Further, diffractive structure HOE is formed on the fourth surface and diffractive structure DOE is formed on the ninth surface which is not illustrated.

### Example 7

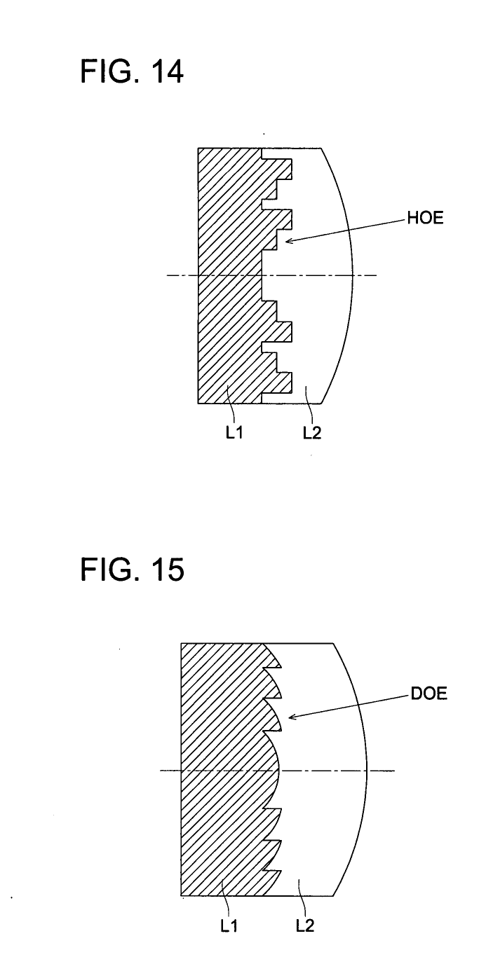

As shown in FIG. 15, the coupling lens of the present example is provided with the first lens portion L1 and the second lens portion L2 which are layered in this order from the light source side. In the coupling lens, diffractive structure DOE is formed, as the first phase structure, on a boundary surface between the first lens portion and the second lens portion.

Table 7 shows lens data of Example 7.

TABLE 7
Example 7 Lens data

| | | | |
|---|---|---|---|
| Total optical system magnification | m_{T1}: 10.3 | m_{T2}: 10.1 | m_{T3}: 7.2 |
| Focal length of coupling lens | f_{CU1} = 25.0 mm | f_{CU2} = 26.0 mm | f_{CU3} = 27.1 mm |
| Optical system magnification of coupling lens | m_{CU1}: −0.342 | m_{CU2}: −0.292 | m_{CU3}: 0.185 |
| Focal length of objective lens | f_{OBJ1} = 3.1 mm | f_{OBJ2} = 3.18 mm | f_{OBJ3} = 3.22 mm |
| Numerical aperture on image side of objective lens | NA_{OBJ1}: 0.65 | NA_{OBJ2}: 0.65 | NA_{OBJ3}: 0.51 |
| Optical system magnification of objective lens | m_{OBJ1}: 1/30.3 | m_{OBJ2}: 1/34.6 | m_{OBJ3}: −1/38.8 |

| i^{th} surface | ri | di(407 nm) | ni(407 nm) | di(655 nm) | ni(655 nm) | di(785 nm) | ni(785 nm) |
|---|---|---|---|---|---|---|---|
| 0 | | 0.00 | | 0.00 | | 0.00 | |
| 1 | ∞ | 6.25 | 1.5299 | 6.25 | 1.5144 | 6.25 | 1.5111 |
| 2 | ∞ | 28.79 | 1.0 | 28.79 | 1.0 | 17.30 | 1.0 |
| 3 | 61.712 | 1.00 | 1.6469 | 0.10 | 1.6155 | 0.10 | 1.6098 |
| 4 | −203.078 | 0.60 | 1.5598 | 0.60 | 1.5407 | 0.60 | 1.5372 |
| 5 | −25.041 | 1.00 | 1.0 | 1.00 | 1.0 | 1.00 | 1.0 |
| 6 | ∞ | 2.80 | 1.0 | 2.80 | 1.0 | 2.80 | 1.0 |
| 7 | ∞ | 5.00 | 1.0 | 5.00 | 1.0 | 5.00 | 1.0 |
| 8 | ∞ | 0.00 | | 0.00 | | 0.00 | |
| (Aperture | | (φ3.902 mm) | | (φ4.024 mm) | | (φ3.375 mm) | |
| diameter) | | | | | | | |
| 9 | 2.0744 | 1.65 | 1.5819 | 1.65 | 1.5860 | 1.65 | 1.5819 |
| 10 | −27.171 | 1.59 | 1.0 | 1.67 | 1.0 | 1.50 | 1.0 |
| 11 | ∞ | 0.6 | 1.6187 | 0.6 | 1.5775 | 1.2 | 1.5706 |
| 12 | ∞ | | | | | | |

*di represents displacement from i^{th} surface to (i + 1)^{th} surface.

Aspheric surface data
4^{th} surface
Optical path difference function,
(HD DVD: 5^{th} order, DVD: 3^{rd} order, CD: 2^{nd} order,
manufacture wavelength 407 nm)

| | |
|---|---|
| C2 | 7.0774E−04 |
| C4 | 3.6345E−06 |

5^{th} surface
Aspheric surface coefficient

| | |
|---|---|
| κ | −1.0069E+00 |
| A1 | 4.2754E−05 |

9^{th} surface
Aspheric surface coefficient

| | |
|---|---|
| κ | −6.1678E−01 |
| A1 | 4.1890E−03 |
| A2 | −1.3000E−03 |
| A3 | 9.6031E−04 |
| A4 | −2.9440E−04 |
| A5 | 4.7955E−05 |
| A6 | −4.7441E−06 |

Optical path difference function
(HD DVD: 6^{th} order, DVD: 4^{th} order, CD: 3^{rd} order,
manufacture wavelength 407 nm)

| | |
|---|---|
| C2 | −1.3376E−03 |
| C4 | −1.4671E−04 |
| C6 | 1.1345E−05 |
| C8 | 2.0565E−07 |
| C10 | −8.0566E−07 |

10^{th} surface
Aspheric surface coefficient

| | |
|---|---|
| κ | −4.3483E+03 |
| A1 | 4.1317E−04 |
| A2 | 4.8894E−03 |
| A3 | −3.2631E−03 |
| A4 | 8.7862E−04 |
| A5 | −1.1924E−04 |
| A6 | 6.2985E−06 |

As shown in Table 7, the coupling lens of the present example is compatible for HD, DVD and CD, and it is established to have focal length f_{CU1} of 25.0 mm and magnification m_{CU1} of −0.342 for wavelength λ1 of 407 nm, focal length f_{CU2} of 26.0 mm and magnification m_{CU2} of −0.292 for wavelength λ2 of 655 nm, and focal length f_{CU3} of 27.1 mm and magnification m_{CU3} of 0.185 for wavelength λ3 of 785 nm.

Material A forming the first lens portion L1 is established to have refractive index nd of 1.62 for d line and Abbe number νd of 40.0 for d line, while, material B forming the second lens portion L2 is established to have refractive index nd of 1.5435 for d line and Abbe number νd of 56.7 for d line.

Further, each of an incident surface (third surface) of the first lens portion and a boundary surface (fourth surface) between the first lens portion and the second lens portion is constituted with a flat surface, and each of an emitting surface (fifth surface) of the second lens portion, an incident surface (ninth surface) and an emitting surface (tenth surface) of an objective optical element is formed to be an aspheric surface.

Further, diffractive structure DOE is formed on a boundary surface (fourth surface) between the first lens portion and the second lens portion, and diffractive structure DOE is formed on the ninth surface which is not illustrated.

### INDUSTRIAL APPLICABILITY

The present invention provides a coupling lens capable of being compatible for a high density optical disc and CD whose wavelength ratio of working light fluxes is substantially 1:2, and of causing these two light fluxes to emit at different angles each other by utilizing a phase structure, and an optical pickup apparatus carrying this coupling lens.

1. A coupling lens for an optical pickup apparatus, comprising:
a first lens portion comprising a material whose Abbe number νd1 for d line satisfies 0<νd1≦40; and
a first phase structure arranged in the first lens portion.

2. The coupling lens of claim 1,
wherein the coupling lens is used for the optical pickup apparatus at least
reproducing and/or recording information for a first optical information recording medium having a protective substrate with a thickness t1 by using a light flux with a wavelength λ1 emitted from a first light source, and
reproducing and/or recording information for a third optical information recording medium having a protective substrate with a thickness t3 (1.44×t1≦t3) by using a light flux with a wavelength λ3 (1.9×λ1≦λ3≦2.2×λ1) emitted from a third light source, and
the coupling lens transmits the light fluxes with the wavelengths λ1 and λ3.

3. The coupling lens of claim 2,
wherein the coupling lens is used for the optical pickup apparatus at least
reproducing and/or recording information for a first optical information recording medium having a protective substrate with a thickness t1 by using a light flux with a wavelength λ1 emitted from a first light source,
reproducing and/or recording information for a second optical information recording medium having a protective substrate with a thickness t2 (0.9×t1≦t2) by using a light flux with a wavelength λ2 (1.5×λ1≦λ2≦1.8×λ1) emitted from a second light source, and
reproducing and/or recording information for a third optical information recording medium having a protective substrate with a thickness t3 (1.6×t2≦t3≦2.4×t2) by using a light flux with a wavelength λ3 (1.9×λ1≦λ3≦2.2×λ1) emitted from a third light source, and
the coupling lens transmits the light fluxes with the wavelengths λ1, λ2 and λ3.

4. The coupling lens of claim 1, further comprising:
a second lens portion whose Abbe number νd2 for d line satisfies νd1<νd2.

5. The coupling lens of claim 4,
wherein the first lens portion and the second lens portion are layered along an optical axis, and
the first phase structure is arranged at a boundary surface between the first lens portion and the second lens portion.

6. The coupling lens of claim 4,
wherein the first lens portion and the second lens portion are layered along an optical axis, and
the first phase structure is arranged at a boundary surface between the first lens portion and an air space.

7. The coupling lens of claim 1,
wherein the first phase structure comprises a plurality of patterns arranged concentrically, and each of the plurality of patterns has a cross section including an optical axis in a stepped shape.

8. The coupling lens of claim 1,
wherein the first phase structure
comprises a plurality of ring-shaped zones concentrically arranged around an optical axis, and
has a cross section including the optical axis in a serrated shape.

9. The coupling lens of claim 2, satisfying m_{CU1}≠m_{CU3},
where m_{CU1} is an optical system magnification of the coupling lens for the light flux with the wavelength λ1, and
m_{CU3} is an optical system magnification of the coupling lens for the light flux with the wavelength λ3.

10. The coupling lens of claim 3, satisfying m_{CU1}≠m_{CU2},
where m_{CU1} is an optical system magnification of the coupling lens for the light flux with the wavelength λ1, and
m_{CU2} is an optical system magnification of the coupling lens for the light flux with the wavelength λ2.

11. The coupling lens of claim 1,
wherein the first phase structure is a diffractive structure.

12. The coupling lens of claim 4, satisfying 40<νd2≦70.

13. The coupling lens of claim 4, further comprising:
a second phase structure arranged at a boundary surface between the second lens portion and an air space.

14. The coupling lens of claim 13,
wherein the second phase structure
comprises a plurality of ring-shaped zones concentrically arranged around an optical axis, and
has a cross section including the optical axis in a serrated shape.

15. The coupling lens of claim 1,
wherein the coupling lens is used for the optical pickup apparatus at least
reproducing and/or recording information for a first optical information recording medium having a protective substrate with a thickness t1 by using a light flux with a wavelength λ1 emitted from a first light source, and
reproducing and/or recording information for a third optical information recording medium having a protective substrate with a thickness t3 (1.44×t1≦t3) by using a light flux with a wavelength λ3 (1.9×λ1≦λ3≦2.2×λ1) emitted from a third light source,
the coupling lens transmits the light fluxes with the wavelengths λ1 and λ3, and
the coupling lens emits a light flux with the wavelength λ1 as a convergent light flux and emits a light flux with the wavelength λ3 as a divergent light flux, for recording and/or reproducing information using the optical pickup apparatus.

16. The coupling lens of claim 15,
wherein the coupling lens is used for the optical pickup apparatus at least
reproducing and/or recording information for a first optical information recording medium having a protective substrate with a thickness t1 by using a light flux with a wavelength λ1 emitted from a first light source,
reproducing and/or recording information for a second optical information recording medium having a protective substrate with a thickness t2 (0.9×t1≦t2) by using a light flux with a wavelength λ2 (1.5×λ1≦λ2≦1.8×λ1) emitted from a second light source, and
reproducing and/or recording information for a third optical information recording medium having a protective substrate with a thickness t3 (1.6×t2≦t3≦2.4×t2) by using a light flux with a wavelength λ3 (1.9×λ1≦λ3≦2.2×λ1) emitted from a third light source,
the coupling lens transmits the light fluxes with the wavelengths λ1, λ2 and λ3, and
the coupling lens emits a light flux with the wavelength λ1 as a convergent light flux and emits a light flux with the wavelength λ3 as a divergent light flux, for recording and/or reproducing information using the optical pickup apparatus.

17. The coupling lens of claim 16,
wherein the coupling lens emits a light flux with the wavelength λ2 as a convergent light flux for recording and/or reproducing information using the optical pickup apparatus.

18. The coupling lens of claim 1,
wherein the coupling lens is used for the optical pickup apparatus at least
reproducing and/or recording information for a first optical information recording medium having a protective substrate with a thickness t1 by using a light flux with a wavelength λ1 emitted from a first light source, and
reproducing and/or recording information for a third optical information recording medium having a protective substrate with a thickness t3 (1.44×t1≦t3) by using a light flux with a wavelength λ3 (1.9×λ1≦λ3≦2.2×λ1) emitted from a third light source,
the coupling lens transmits the light fluxes with the wavelengths λ1 and λ3, and
the coupling lens comprises a collimating function for at least one light flux between the light fluxes with the wavelengths λ1 and λ2.

19. The coupling lens of claim 18,
wherein the coupling lens is used for the optical pickup apparatus at least
reproducing and/or recording information for a first optical information recording medium having a protective substrate with a thickness t1 by using a light flux with a wavelength λ1 emitted from a first light source,
reproducing and/or recording information for a second optical information recording medium having a protective substrate with a thickness t2 (0.9×t1≦t2) by using a light flux with a wavelength λ2 (1.5×λ1≦λ2≦1.8×λ1) emitted from a second light source, and
reproducing and/or recording information for a third optical information recording medium having a protective substrate with a thickness t3 (1.6×t2≦t3≦2.4×t2) by using a light flux with a wavelength λ3 (1.9×λ1≦λ3≦2.2×λ1) emitted from a third light source,
the coupling lens transmits the light fluxes with the wavelengths λ1, λ2 and λ3, and
the coupling lens comprises a collimating function for at least one light flux among the light fluxes with the wavelengths λ1, λ2 and λ3.

20. An optical pickup apparatus comprising:
a first light source emitting a light flux with a wavelength λ1 for reproducing and/or recording information for a first optical information recording medium having a protective substrate with a thickness t1;
a third light source emitting a light flux with a wavelength λ3 (1.9×λ1≦λ3≦2.2×λ1) for reproducing and/or recording information for a third optical information recording medium having a protective substrate with a thickness t3 (1.44×t1≦t3);
an objective optical element converging the light fluxes with the wavelengths λ1 and λ3 onto the first optical information recording medium and the third optical information recording medium, respectively; and
the coupling lens of claim 1.

21. The optical pickup apparatus of claim 20, comprising:
a first light source emitting a light flux with a wavelength λ1 for reproducing and/or recording information for a first optical information recording medium having a protective substrate with a thickness t1;
a second light source emitting a light flux with a wavelength λ2 (1.5×λ1≦λ2≦1.8×λ1) for reproducing and/or recording information for a second optical information recording medium having a protective substrate with a thickness t2 (0.9×t1≦t2);
a third light source emitting a light flux with a wavelength λ3 (1.9×λ1≦λ3≦2.2×λ1) for reproducing and/or recording information for a third optical information recording medium having a protective substrate with a thickness t3 (1.6×t2≦t3≦2.4×t2);
an objective optical element converging the light fluxes with the wavelengths λ1, λ2, and λ3 onto the first optical information recording medium, the second optical information recording medium, and the third optical information recording medium, respectively; and
the coupling lens of claim 20.

22. The optical pickup apparatus of claim 20,
wherein the first light source and the third light source are integrally formed as one body.

23. The optical pickup apparatus of claim 21,
wherein the second light source and the third light source are integrally formed as one body.

24. The optical pickup apparatus of claim 21,
wherein the first light source, the second light source and the third light source are integrally formed as one body.
